(19) United States
(12) Patent Application Publication
(10) Pub. No.: US 2015/0237866 A1
(43) Pub. Date: Aug. 27, 2015

(54) ANTIMICROBIAL THERMOPLASTIC POLYMER COMPOSITIONS

(71) Applicant: SABIC Innovative Plastics IP B.V., Bergen op Zoom (NL)

(72) Inventors: Alexander van Goudswaard, Goes (NL); Theo Hoeks, Bergen op Zoom (NL); Hans Looij, Bergen op Zoom (NL); Jan Henk Kamps, Bergen op Zoom (NL)

(21) Appl. No.: 14/188,383

(22) Filed: Feb. 24, 2014

(51) Int. Cl. A01N 59/16; A01N 55/02

(52) U.S. Cl. CPC A01N 59/16; A01N 55/02

(57) ABSTRACT

Disclosed herein are methods and compositions of thermoplastic compositions with antimicrobial properties. The resulting compositions, comprising one or more thermoplastic polymers, a zinc additive component, and an acid stabilizer component, can be used in the manufacture of articles requiring antimicrobial protection while still retaining the advantageous physical properties of thermoplastic compositions. This abstract is intended as a scanning tool for purposes of searching in the particular art and is not intended to be limiting of the present invention.

### FIELD OF INVENTION

The present invention relates to antimicrobial thermoplastic compositions comprising one or more polymer, a zinc additive component, and an acid stabilizer component.

### BACKGROUND OF THE INVENTION

With increasing life expectancies and a growing world population of the world and the resistance bacteria develop against antibiotic treatments; more attention has been shifted to preventative strategies such as expanded hygiene and antimicrobial materials.

Next to these global trends, the need, based on market feedback is growing since hospitals and other health care entities are held responsible for infections that patients acquire during their stay. Healthcare associated infections now number 1.7 million infections per year, accounting for nearly 100,000 deaths, and costing hospitals up to $45 billion annually.

Although antimicrobial polymer blends have been developed before, so far transparent, antimicrobial polymer compositions, such as polycarbonates, with retention of their key properties are not available. Earlier materials where rationalized because of the scattered market and variety of test versus different microorganisms.

Accordingly, it would be beneficial to provide thermoplastic compositions which can exhibit antimicrobial activity while retaining other desirable thermoplastics properties. These needs and other needs are met by the various aspects of the present invention.

### SUMMARY OF THE INVENTION

In one aspect, the invention relates to thermoplastic compositions exhibiting antimicrobial properties.

In another aspect, the invention relates a thermoplastic composition comprising:
a) a thermoplastic polymer component comprising a polycarbonate, polyalkylene terephthalate, polypropylene (PP), polyphenylene oxide (PPO), polyetherimide (PEI), or a combination thereof;
b) a zinc additive component; and
c) an acid stabilizer component.

In another aspect, the invention relates to a thermoplastic composition comprising:
a) from about 30 wt % to less than 100 wt % of a thermoplastic polymer component comprising a polycarbonate, polyalkylene terephthalate, polypropylene (PP), polyphenylene oxide (PPO), polyetherimide (PEI), or a combination thereof;
b) from greater than 0 wt % to about 10 wt % of a zinc additive component; and
c) from greater than 0 wt % to about 5 wt % of an acid stabilizer component.

In another aspect, the invention relates to a thermoplastic composition, comprising:
a) from about 40 wt % to about 80 wt % of a thermoplastic polymer component comprising at least one polycarbonate;
b) from greater than 0 wt % to about 10 wt % of a zinc additive component comprising zinc, zinc oxide, zinc acetate, zinc stearate, zinc carbonate, zinc nitrate, or a salt thereof, or a combination thereof; and
c) from greater than 0 wt % to about 10 wt % of an acid stabilizer component comprising phosphorous acid, phosphoric acid, mono zinc phosphate, mono sodium phosphate, or sodium acid pyrophosphate, or a combination thereof.

In another aspect, the invention relates to a method for forming an antimicrobial thermoplastic blend comprising, combining:
a) a thermoplastic polymer component comprising a polycarbonate, polyalkylene terephthalate, polypropylene (PP), polyphenylene oxide (PPO), polyetherimide (PEI), or a combination thereof;
b) a zinc additive component; and
c) an acid stabilizer component.

In another aspect, the invention relates a method of improving antimicrobial properties of a thermoplastic composition, the method comprising, combining:
a) a thermoplastic polymer component;
b) a zinc additive component; and
c) an acid stabilizer component;
   wherein a molded part formed from the thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component.

In another aspect, the invention relates to a method of inhibiting microorganism growth on a thermoplastic composition, the method comprising, combining:
a) a thermoplastic polymer component;
b) a zinc additive component; and
c) an acid stabilizer component;
   wherein after a 24 hour incubation, a molded part formed from the thermoplastic composition exhibits a lower microorganism colony forming unit (CFU) value as determined according to JIS Z 2801, compared to a molded part formed from an identical reference composition comprising the same thermoplastic component, and the same weight percentage of the same acid stabilizer component, but in the absence of the zinc additive component.

In another aspect, the invention also provides articles and products comprising the disclosed compositions.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated in and constitute a part of this specification, illustrate several aspects and together with the description serve to explain the principles of the invention.

FIG. 1 shows a visual schematic of the plating and counting methods used during antimicrobial testing described herein.

FIG. 2 shows a visual schematic of incubation and serial dilution methods used during antimicrobial testing of the samples described herein.

FIG. 3 shows a visual schematic of incubation and serial dilution methods used during antimicrobial testing of the samples described herein.

FIG. 4 shows a graph representing data measuring zinc additive induced molecular weight loss of compositions during extrusion.

FIG. 5 shows a graph representing data molecular weight stabilization of compositions according to the present invention.

FIG. 6 shows a graph representing data antimicrobial efficiency of compositions according to the present invention.

FIG. 7 shows a visual schematic of microorganism biofilm formation.

### DETAILED DESCRIPTION OF THE INVENTION

The present invention can be understood more readily by reference to the following detailed description of the invention and the Examples included therein.

Before the present compounds, compositions, articles, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### DEFINITIONS

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate polymer” includes mixtures of two or more polycarbonate polymers.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

As used herein, the term “effective amount” refers to an amount that is sufficient to achieve the desired modification of a physical property of the composition or material. For example, an “effective amount” of a zinc additive refers to an amount that is sufficient to achieve the desired improvement in the property modulated by the formulation component, e.g., improved antimicrobial properties, under applicable test conditions and without adversely affecting other specified properties. The specific level in terms of wt % in a composition required as an effective amount will depend upon a variety of factors including the amount and type of polycarbonate, amount and type of impact modifier, amount and type of talc, and end use of the article made using the composition.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (“wt %”) of a component, unless specifically stated to the contrary, is based on the total weight of the formulation or composition in which the component is included. For example if a particular element or component in a composition or article is said to have 8% by weight, it is understood that this percentage is relative to a total compositional percentage of 100% by weight.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this invention belongs.

The term “alkyl group” as used herein is a branched or unbranched saturated hydrocarbon group of 1 to 24 carbon atoms, such as methyl, ethyl, n propyl, isopropyl, n butyl, isobutyl, t butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “aralkyl” as used herein is an aryl group having an alkyl, alkynyl, or alkenyl group as defined above attached to the aromatic group. An example of an aralkyl group is a benzyl group.

The term “carbonate group” as used herein is represented by the formula OC(O)OR, where R can be hydrogen, an alkyl, alkenyl, alkynyl, aryl, aralkyl, cycloalkyl, halogenated alkyl, or heterocycloalkyl group described above.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-dihydroxyphenyl radical in a particular compound has the structure:

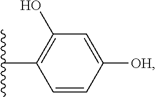 [SMILES: *c1ccc(O)cc1O]

regardless of whether 2,4-dihydroxyphenyl is used to prepare the compound. In some embodiments the radical (for example an alkyl) can be further modified (i.e., substituted alkyl) by having bonded thereto one or more “substituent radicals.” The number of atoms in a given radical is not critical to the present invention unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5,6,7,8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

As used herein, the terms “number average molecular weight” or “Mₙ” can be used interchangeably, and refer to the statistical average molecular weight of all the polymer chains in the sample and is defined by the formula:

$${M}_{n} = \frac{Σ {N}_{i} {M}_{i}}{Σ {N}_{i}} ,$$

where Mᵢ is the molecular weight of a chain and Nᵢ is the number of chains of that molecular weight. Mₙ can be determined for polymers, e.g. polycarbonate polymers, by methods well known to a person having ordinary skill in the art using molecular weight standards, e.g. polycarbonate standards or polystyrene standards, preferably certified or traceable molecular weight standards.

As used herein, the terms “weight average molecular weight” or “Mw” can be used interchangeably, and are defined by the formula:

$${M}_{w} = \frac{Σ {N}_{i} {M}_{i}^{2}}{Σ {N}_{i} {M}_{i}} ,$$

where Mᵢ is the molecular weight of a chain and Nᵢ is the number of chains of that molecular weight. Compared to Mₙ, M_{w} takes into account the molecular weight of a given chain in determining contributions to the molecular weight average. Thus, the greater the molecular weight of a given chain, the more the chain contributes to the M_{w}. M_{w} can be determined for polymers, e.g. polycarbonate polymers, by methods well known to a person having ordinary skill in the art using molecular weight standards, e.g. polycarbonate standards or polystyrene standards, preferably certified or traceable molecular weight standards.

As used herein, the terms “polydispersity index” or “PDI” can be used interchangeably, and are defined by the formula:

$$PDI = \frac{{M}_{w}}{{M}_{n}} .$$

The PDI has a value equal to or greater than 1, but as the polymer chains approach uniform chain length, the PDI approaches unity.

The terms “BisA” or “bisphenol A,” which can be used interchangeably, as used herein refers to a compound having a structure represented by the formula:

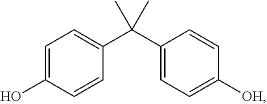 [SMILES: CC(C)(c1ccc(O)cc1)c1ccc(O)cc1]

BisA can also be referred to by the name 4,4′-(propane-2,2-diyl)diphenol; p,p′-isopropylidenebisphenol; or 2,2-bis(4-hydroxyphenyl)propane. BisA has the CAS #80-05-7.

As used herein, “polycarbonate” refers to an oligomer or polymer comprising residues of one or more dihydroxy compounds, e.g. dihydroxy aromatic compounds, joined by carbonate linkages; it also encompasses homopolycarbonates, copolycarbonates, and (co)polyester carbonates.

The terms “residues” and “structural units”, used in reference to the constituents of the polymers, are synonymous throughout the specification.

As used herein, the term “ABS” or “acrylonitrile-butadiene-styrene copolymer” refers to an acrylonitrile-butadiene-styrene polymer which can be an acrylonitrile-butadiene-styrene terpolymer or a blend of styrene-butadiene rubber and styrene-acrylonitrile copolymer.

As used herein, the term “impact modifier” refers to a component of the disclosed impact modified polycarbonate blend compositions wherein the impact modifier is a polymeric material effective in improving the impact properties of the disclosed impact modified polycarbonate blend compositions, e.g. the notched Izod impact strength of the composition. As used herein, an impact modifier can be a one or more polymers such as acrylonitrile butadiene styrene copolymer (ABS), methacrylate butadiene styrene copolymer (MBS), and/or bulk polymerized ABS (BABS).

As used herein the terms “weight percent,” “wt %,” and “wt. %,” which can be used interchangeably, indicate the percent by weight of a given component based on the total weight of the composition, unless otherwise specified. That is, unless otherwise specified, all weight percent values are based on the total weight of the composition. It should be understood that the sum of weight percent values for all components in a disclosed composition or formulation are equal to 100.

As used herein, the term “biofilm” refers to any group of microorganisms in which cells stick to each other on a surface.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Thermoplastic Compositions

As briefly described above, the present disclosure relates in one aspect to thermoplastic compositions with antimicrobial properties. Thus, in a further aspect, the resulting compositions are capable of being used in the production of articles which require antimicrobial protection, such as products used in health care and patient care settings.

In various aspects, the invention pertains to thermoplastic compositions comprising: a) a thermoplastic polymer component comprising a polycarbonate, polyalkylene terephthalate, polypropylene (PP), polyphenylene oxide (PPO), polyetherimide (PEI), or a combination thereof; b) a zinc additive component; and c) an acid stabilizer component.

In another aspect, the invention relates to thermoplastic compositions comprising: a) from about 30 wt % to less than 100 wt % of a thermoplastic polymer component comprising a polycarbonate, polyalkylene terephthalate, polypropylene (PP), polyphenylene oxide (PPO), polyetherimide (PEI), or a combination thereof; b) from greater than 0 wt % to about 10 wt % of a zinc additive component; and c) from greater than 0 wt % to about 5 wt % of an acid stabilizer component.

In another aspect, the invention relates to thermoplastic compositions, comprising: a) from about 40 wt % to about 80 wt % of a thermoplastic polymer component comprising at least one polycarbonate; b) from greater than 0 wt % to about 10 wt % of a zinc additive component comprising zinc, zinc oxide, zinc acetate, zinc stearate, zinc carbonate, zinc nitrate, or a salt thereof, or a combination thereof; and c) from greater than 0 wt % to about 10 wt % of an acid stabilizer component comprising phosphorous acid, phosphoric acid, mono zinc phosphate, mono sodium phosphate, or sodium acid pyrophosphate, or a combination thereof.

### Thermoplastic Polymer Component

In one aspect, the thermoplastic polymer used in the compositions of the invention is an organic polymer. In this aspect, the organic polymer is selected from a wide variety of thermoplastic resins or blends of thermoplastic resins. The thermoplastic polymer also includes blends of one or more thermoplastic resins with one or more thermosetting resins. The thermoplastic polymer can also be a blend of polymers, copolymers, terpolymers, or combinations including at least one of the foregoing organic polymers. In one aspect, examples of the organic polymer are polyethylene (PE), including high-density polyethylene (HDPE), linear low-density polyethylene (LLDPE), low-density polyethylene (LDPE), mid-density polyethylene (MDPE), glycidyl methacrylate modified polyethylene, maleic anhydride functionalized polyethylene, maleic anhydride functionalized elastomeric ethylene copolymers, ethylene-butene copolymers, ethylene-octene copolymers, ethylene-acrylate copolymers, such as ethylene-methyl acrylate, ethylene-ethyl acrylate, and ethylene butyl acrylate copolymers, glycidyl methacrylate functionalized ethylene-acrylate terpolymers, anhydride functionalized ethylene-acrylate polymers, anhydride functionalized ethylene-octene and anhydride functionalized ethylene-butene copolymers, polypropylene (PP), maleic anhydride functionalized polypropylene, glycidyl methacrylate modified polypropylene, polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polyoxymethylenes, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polyurethanes, or the like, or a combination including at least one of the foregoing organic polymers.

Specific non-limiting examples of blends of thermoplastic resins include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, and combinations including at least one of the foregoing blends of thermoplastic resins.

In another aspect, the disclosed thermoplastic compositions of the present invention comprise a polycarbonate polymer composition. In various aspects, the disclosed thermoplastic compositions have antimicrobial properties while maintaining useful mechanical properties.

In one aspect, a polycarbonate can comprise any polycarbonate material or mixture of materials, for example, as recited in U.S. Pat. No. 7,786,246, which is hereby incorporated in its entirety for the specific purpose of disclosing various polycarbonate compositions and methods. The term polycarbonate can be further defined as compositions have repeating structural units of the formula (1):

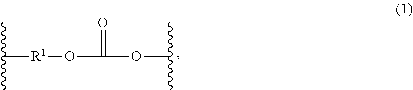

in which at least 60 percent of the total number of R¹ groups are aromatic organic radicals and the balance thereof are aliphatic, alicyclic, or aromatic radicals. Preferably, each R¹ is an aromatic organic radical and, more preferably, a radical of the formula (2):

-A¹-Y¹-A²- (2),

wherein each of A¹ and A² is a monocyclic divalent aryl radical and Y¹ is a bridging radical having one or two atoms that separate A¹ from A². In various aspects, one atom separates A¹ from A² or example, radicals of this type include, but are not limited to, radicals such as —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ is preferably a hydrocarbon group or a saturated hydrocarbon group such as methylene, cyclohexylidene, or isopropylidene.

In a further aspect, polycarbonates can be produced by the interfacial reaction of dihydroxy compounds having the formula HO—R¹—OH, which includes dihydroxy compounds of formula (3):

HO-A¹-Y¹-A²-OH (3),

wherein Y¹, A¹ and A² are as described above. Also included are bisphenol compounds of general formula (4):

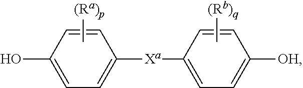

wherein R^{a} and R^{b} each represent a halogen atom or a monovalent hydrocarbon group and can be the same or different; p and q are each independently integers from 0 to 4; and X^{a} represents one of the groups of formula (5):

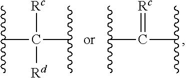

wherein R^{c} and R^{d} each independently represent a hydrogen atom or a monovalent linear or cyclic hydrocarbon group and R^{e} is a divalent hydrocarbon group.

In various aspects, examples of suitable dihydroxy compounds include the dihydroxy-substituted hydrocarbons disclosed by name or formula (generic or specific) in U.S. Pat. No. 4,217,438. A nonexclusive list of specific examples of suitable dihydroxy compounds includes the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, 2,7-dihydroxycarbazole, 3,3-bis(4-hydroxyphenyl)phthalimidine, 2-phenyl-3,3-bis-(4-hydroxyphenyl)phthalimidine (PPPBP), and the like, as well as mixtures including at least one of the foregoing dihydroxy compounds.

In a further aspect, examples of the types of bisphenol compounds that can be represented by formula (3) includes 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl) n-butane, 2,2-bis(4-hydroxy-1-methylphenyl)propane, and 1,1-bis(4-hydroxy-t-butylphenyl)propane. Combinations including at least one of the foregoing dihydroxy compounds can also be used.

In various aspects, a polycarbonate can employ two or more different dihydroxy compounds or a copolymer of a dihydroxy compounds with a glycol or with a hydroxy- or acid-terminated polyester or with a dibasic acid or hydroxy acid in the event a carbonate copolymer rather than a homopolymer is desired for use. Polyarylates and polyester-carbonate resins or their blends can also be employed. Branched polycarbonates are also useful, as well as blends of linear polycarbonate and a branched polycarbonate. The branched polycarbonates can be prepared by adding a branching agent during polymerization.

In a further aspect, the branching agents include polyfunctional organic compounds containing at least three functional groups selected from hydroxyl, carboxyl, carboxylic anhydride, haloformyl, and mixtures thereof. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents can be added at a level of from 0.05-2.0 weight percent. Branching agents and procedures for making branched polycarbonates are described in U.S. Pat. Nos. 3,635,895 and 4,001,184. All types of polycarbonate end groups are contemplated as being useful in the thermoplastic composition.

In a further aspect, the polycarbonates are based on bisphenol A, in which each of A¹ and A² is p-phenylene and Y¹ is isopropylidene. In a still further aspect, the molecular weight (Mw) of the polycarbonate is about 10,000 to about 100,000. In a yet further aspect, the polycarbonate has a Mw of about 15,000 to about 55,000. In an even further aspect, the polycarbonate has a Mw of about 18,000 to about 40,000.

Polycarbonates, including isosorbide-based polyester-polycarbonate, can comprise copolymers comprising carbonate units and other types of polymer units, including ester units, and combinations comprising at least one of homopolycarbonates and copolycarbonates. An exemplary polycarbonate copolymer of this type is a polyester carbonate, also known as a polyester-polycarbonate. Such copolymers further contain carbonate units derived from oligomeric ester-containing dihydroxy compounds (also referred to herein as hydroxy end-capped oligomeric acrylate esters).

In one aspect, polycarbonates can be manufactured using an interfacial phase transfer process or melt polymerization. Although the reaction conditions for interfacial polymerization can vary, an exemplary process generally involves dissolving or dispersing a dihydric phenol reactant in aqueous caustic soda or potash, adding the resulting mixture to a water-immiscible solvent medium such as for example methylene chloride, and contacting the reactants with a carbonate precursor (such as phosgene) in the presence of a catalyst such as, for example, triethylamine or a phase transfer catalyst salt, under controlled pH conditions of, for example, from about 8 to about 10.

The polycarbonate compounds and polymers disclosed herein can, in various aspects, be prepared by a melt polymerization process. Generally, in the melt polymerization process, polycarbonates are prepared by co-reacting, in a molten state, the dihydroxy reactant(s) (i.e., isosorbide, aliphatic diol and/or aliphatic diacid, and any additional dihydroxy compound) and a diaryl carbonate ester, such as diphenyl carbonate, or more specifically in an aspect, an activated carbonate such as bis(methyl salicyl)carbonate, in the presence of a transesterification catalyst. The reaction can be carried out in typical polymerization equipment, such as one or more continuously stirred reactors (CSTRs), plug flow reactors, wire wetting fall polymerizers, free fall polymerizers, wiped film polymerizers, BANBURY® mixers, single or twin screw extruders, or combinations of the foregoing. In one aspect, volatile monohydric phenol can be removed from the molten reactants by distillation and the polymer is isolated as a molten residue.

The melt polymerization can include a transesterification catalyst comprising a first catalyst, also referred to herein as an alpha catalyst, comprising a metal cation and an anion. In an aspect, the cation is an alkali or alkaline earth metal comprising Li, Na, K, Cs, Rb, Mg, Ca, Ba, Sr, or a combination comprising at least one of the foregoing. The anion is hydroxide (OH⁻), superoxide (O²⁻), thiolate (HS⁻), sulfide (S²⁻), a C₁₋₂₀ alkoxide, a C₆₋₂₀ aryloxide, a C₁₋₂₀ carboxylate, a phosphate including biphosphate, a C₁₋₂₀ phosphonate, a sulfate including bisulfate, sulfites including bisulfites and metabisulfites, a C₁₋₂₀ sulfonate, a carbonate including bicarbonate, or a combination comprising at least one of the foregoing. In another aspect, salts of an organic acid comprising both alkaline earth metal ions and alkali metal ions can also be used. Salts of organic acids useful as catalysts are illustrated by alkali metal and alkaline earth metal salts of formic acid, acetic acid, stearic acid and ethyelenediaminetetraacetic acid. The catalyst can also comprise the salt of a non-volatile inorganic acid. By “nonvolatile”, it is meant that the referenced compounds have no appreciable vapor pressure at ambient temperature and pressure. In particular, these compounds are not volatile at temperatures at which melt polymerizations of polycarbonate are typically conducted. The salts of nonvolatile acids are alkali metal salts of phosphites; alkaline earth metal salts of phosphites; alkali metal salts of phosphates; and alkaline earth metal salts of phosphates. Exemplary transesterification catalysts include, lithium hydroxide, sodium hydroxide, potassium hydroxide, cesium hydroxide, magnesium hydroxide, calcium hydroxide, barium hydroxide, lithium formate, sodium formate, potassium formate, cesium formate, lithium acetate, sodium acetate, potassium acetate, lithium carbonate, sodium carbonate, potassium carbonate, lithium methoxide, sodium methoxide, potassium methoxide, lithium ethoxide, sodium ethoxide, potassium ethoxide, lithium phenoxide, sodium phenoxide, potassium phenoxide, sodium sulfate, potassium sulfate, NaH₂PO₃, NaH₂PO₄, Na₂H₂PO₃, KH₂PO₄, CsH₂PO₄, Cs₂H₂PO₄, Na₂SO₃, Na₂S₂O₅, sodium mesylate, potassium mesylate, sodium tosylate, potassium tosylate, magnesium disodium ethylenediamine tetraacetate (EDTA magnesium disodium salt), or a combination comprising at least one of the foregoing. It will be understood that the foregoing list is exemplary and should not be considered as limited thereto. In one aspect, the transesterification catalyst is an alpha catalyst comprising an alkali or alkaline earth salt. In an exemplary aspect, the transesterification catalyst comprising sodium hydroxide, potassium hydroxide, sodium carbonate, potassium carbonate, sodium methoxide, potassium methoxide, NaH₂PO₄, or a combination comprising at least one of the foregoing.

The amount of alpha catalyst can vary widely according to the conditions of the melt polymerization, and can be about 0.001 to about 500 μmol. In an aspect, the amount of alpha catalyst can be about 0.01 to about 20 μmol, specifically about 0.1 to about 10 μmol, more specifically about 0.5 to about 9 μmol, and still more specifically about 1 to about 7 μmol, per mole of aliphatic diol and any other dihydroxy compound present in the melt polymerization.

In another aspect, a second transesterification catalyst, also referred to herein as a beta catalyst, can optionally be included in the melt polymerization process, provided that the inclusion of such a second transesterification catalyst does not significantly adversely affect the desirable properties of thepolycarbonate. Exemplary transesterification catalysts can further include a combination of a phase transfer catalyst of formula (R³)₄Q⁺X above, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalyst salts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. Examples of such transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing. Other melt transesterification catalysts include alkaline earth metal salts or alkali metal salts. In various aspects, where a beta catalyst is desired, the beta catalyst can be present in a molar ratio, relative to the alpha catalyst, of less than or equal to 10, specifically less than or equal to 5, more specifically less than or equal to 1, and still more specifically less than or equal to 0.5. In other aspects, the melt polymerization reaction disclosed herein uses only an alpha catalyst as described hereinabove, and is substantially free of any beta catalyst. As defined herein, “substantially free of” can mean where the beta catalyst has been excluded from the melt polymerization reaction. In one aspect, the beta catalyst is present in an amount of less than about 10 ppm, specifically less than 1 ppm, more specifically less than about 0.1 ppm, more specifically less than or equal to about 0.01 ppm, and more specifically less than or equal to about 0.001 ppm, based on the total weight of all components used in the melt polymerization reaction.

In one aspect, an end-capping agent (also referred to as a chain-stopper) can optionally be used to limit molecular weight growth rate, and so control molecular weight in the polycarbonate. Exemplary chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p- and tertiary-butyl phenol, cresol, and monoethers of diphenols, such as p-methoxyphenol. Alkyl-substituted phenols with branched chain alkyl substituents having 8 to 9 carbon atoms can be specifically mentioned.

In another aspect, endgroups can be derived from the carbonyl source (i.e., the diaryl carbonate), from selection of monomer ratios, incomplete polymerization, chain scission, and the like, as well as any added end-capping groups, and can include derivatizable functional groups such as hydroxy groups, carboxylic acid groups, or the like. In one aspect, the endgroup of a polycarbonate, including anpolycarbonate polymer as defined herein, can comprise a structural unit derived from a diaryl carbonate, where the structural unit can be an endgroup. In a further aspect, the endgroup is derived from an activated carbonate. Such endgroups can be derived from the transesterification reaction of the alkyl ester of an appropriately substituted activated carbonate, with a hydroxy group at the end of a polycarbonate polymer chain, under conditions in which the hydroxy group reacts with the ester carbonyl from the activated carbonate, instead of with the carbonate carbonyl of the activated carbonate. In this way, structural units derived from ester containing compounds or substructures derived from the activated carbonate and present in the melt polymerization reaction can form ester endgroups.

In one aspect, the melt polymerization reaction can be conducted by subjecting the reaction mixture to a series of temperature-pressure-time protocols. In some aspects, this involves gradually raising the reaction temperature in stages while gradually lowering the pressure in stages. In one aspect, the pressure is reduced from about atmospheric pressure at the start of the reaction to about 1 millibar (100 Pa) or lower, or in another aspect to 0.1 millibar (10 Pa) or lower in several steps as the reaction approaches completion. The temperature can be varied in a stepwise fashion beginning at a temperature of about the melting temperature of the reaction mixture and subsequently increased to final temperature. In one aspect, the reaction mixture is heated from room temperature to about 150° C. In such an aspect, the polymerization reaction starts at a temperature of about 150° C. to about 220° C. In another aspect, the polymerization temperature can be up to about 220° C. In other aspects, the polymerization reaction can then be increased to about 250° C. and then optionally further increased to a temperature of about 320° C., and all subranges there between. In one aspect, the total reaction time can be from about 30 minutes to about 200 minutes and all subranges there between. This procedure will generally ensure that the reactants react to give polycarbonates with the desired molecular weight, glass transition temperature and physical properties. The reaction proceeds to build the polycarbonate chain with production of ester-substituted alcohol by-product such as methyl salicylate. In one aspect, efficient removal of the by-product can be achieved by different techniques such as reducing the pressure. Generally the pressure starts relatively high in the beginning of the reaction and is lowered progressively throughout the reaction and temperature is raised throughout the reaction.

In one aspect, the progress of the reaction can be monitored by measuring the melt viscosity or the weight average molecular weight of the reaction mixture using techniques known in the art such as gel permeation chromatography. These properties can be measured by taking discrete samples or can be measured on-line. After the desired melt viscosity and/or molecular weight is reached, the final polycarbonate product can be isolated from the reactor in a solid or molten form. It will be appreciated by a person skilled in the art, that the method of making aliphatic homopolycarbonate and aliphatic-aromatic copolycarbonates as described in the preceding sections can be made in a batch or a continuous process and the process disclosed herein is preferably carried out in a solvent free mode. Reactors chosen should ideally be self-cleaning and should minimize any “hot spots.” However, vented extruders similar to those that are commercially available can be used.

The compositions of the present invention can be blended with the aforementioned ingredients by a variety of methods involving intimate admixing of the materials with any additional additives desired in the formulation. Because of the availability of melt blending equipment in commercial polymer processing facilities, melt processing methods are generally preferred. Illustrative examples of equipment used in such melt processing methods include: co-rotating and counter-rotating extruders, single screw extruders, co-kneaders, disc-pack processors and various other types of extrusion equipment. The temperature of the melt in the present process is preferably minimized in order to avoid excessive degradation of the resins. It is often desirable to maintain the melt temperature between about 230° C. and about 350° C. in the molten resin composition, although higher temperatures can be used provided that the residence time of the resin in the processing equipment is kept short. In some embodiments the melt processed composition exits processing equipment such as an extruder through small exit holes in a die. The resulting strands of molten resin are cooled by passing the strands through a water bath. The cooled strands can be chopped into small pellets for packaging and further handling.

Thermoplastic compositions comprising blended polycarbonate compositions can be manufactured by various methods. For example, powdered polycarbonate, other polymer (if present), and/or other optional components are first blended, optionally with fillers in a HENSCHEL-Mixer® high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

In one aspect, the polycarbonate component of the thermoplastic composition comprises Bisphenol A residues. In a further aspect, the polycarbonate component of the thermoplastic composition is prepared by an interfacial polymerization process.

In reference to the weight average molecular weight (M_{w}) of the polycarbonate component, including the first and second polycarbonate components, of the present invention, it is understood that the M_{w} is the absolute M_{w} determined by gel permeation chromatography relative to traceable polycarbonate standards.

In a further aspect, the polycarbonate component of the thermoplastic composition is present in an amount from about 10 wt % to about 70 wt %. In a still further aspect, the polycarbonate component of the thermoplastic composition is present in an amount from about 10 wt % to about 50 wt %. In a yet further aspect, the polycarbonate component of the thermoplastic composition is present in an amount from about 30 wt % to about 70 wt %. In an even further aspect, the polycarbonate component of the thermoplastic composition is present in an amount from about 10 wt % to about 40 wt %.

In one aspect, the polycarbonate component is present in an amount from about 25 wt % to about 50 wt %. In a further aspect, the polycarbonate component is present in an amount from about 25 wt % to about 45 wt %. In a yet further aspect, the polycarbonate component is present in an amount from about 25 wt % to about 40 wt %. In an even further aspect, the polycarbonate component is present in an amount from about 25 wt % to about 35 wt %. In a still further aspect, the polycarbonate component is present in an amount from about 25 wt % to about 30 wt %.

In one aspect, the polycarbonate polymer component is present in an amount of about 20 wt %. In another aspect, the polycarbonate polymer component is present in an amount of about 22 wt %. In still another aspect, the polycarbonate polymer component is present in an amount of about 23 wt %. In still another aspect, the polycarbonate polymer component is present in an amount of about 24 wt %. In still another aspect, the polycarbonate polymer component is present in an amount of about 25 wt %.

In one aspect, the polycarbonate polymer component is a high flow polycarbonate. In another aspect, the polycarbonate polymer component has a melt volume flow rate (MFR) of at least about 20 grams/10 minutes when measured at 300° C. and under a load of 1.2 kg according to ASTM D1238. In still another aspect, the polycarbonate polymer component has a melt volume flow rate (MFR) of at least about 22 grams/10 minutes when measured at 300° C. and under a load of 1.2 kg according to ASTM D1238. In still another aspect, the polycarbonate polymer component has a melt volume flow rate (MFR) from about 17 grams/10 minutes to about 32 grams/10 minutes when measured at 300° C. and under a load of 1.2 kg according to ASTM D1238. In still another aspect, the polycarbonate polymer component has a melt volume flow rate (MFR) from about 20 grams/10 minutes to about 30 grams/10 minutes when measured at 300° C. and under a load of 1.2 kg according to ASTM D1238. In still another aspect, the polycarbonate polymer component has a melt volume flow rate (MFR) from about 22 grams/10 minutes to about 29 grams/10 minutes when measured at 300° C. and under a load of 1.2 kg according to ASTM D1238. In still another aspect, the polycarbonate polymer component has a melt volume flow rate (MFR) from about 23 grams/10 minutes to about 29 grams/10 minutes when measured at 300° C. and under a load of 1.2 kg according to ASTM D1238.

In one aspect, the polycarbonate component of the thermoplastic composition has a weight average molecular weight of from about 15,000 g/mol to about 100,000 g/mol on an absolute polycarbonate molecular weight scale. In a still further aspect, the polycarbonate component has a weight average molecular weight of from about 15,000 g/mol to about 50,000 g/mol on an absolute polycarbonate molecular weight scale. In a yet further aspect, the polycarbonate component has a weight average molecular weight of from about 15,000 g/mol to about 45,000 g/mol on an absolute polycarbonate molecular weight scale. In an even further aspect, the polycarbonate component has a weight average molecular weight of from about 15,000 g/mol to about 40,000 g/mol on an absolute polycarbonate molecular weight scale. In an even further aspect, the polycarbonate component has a weight average molecular weight of from about 15,000 g/mol to about 35,000 g/mol on an absolute polycarbonate molecular weight scale. In an even further aspect, the polycarbonate component has a weight average molecular weight of from about 15,000 g/mol to about 30,000 g/mol on an absolute polycarbonate molecular weight scale. In an even further aspect, the polycarbonate component has a weight average molecular weight of from about 15,000 g/mol to about 25,000 g/mol on an absolute polycarbonate molecular weight scale.

In one aspect, the polycarbonate component has a weight average molecular weight of from about 20,000 g/mol to about 100,000 g/mol on an absolute polycarbonate molecular weight scale. In a further aspect, the polycarbonate component has a weight average molecular weight of from about 20,000 g/mol to about 50,000 g/mol on an absolute polycarbonate molecular weight scale. In a yet further aspect, the polycarbonate component has a weight average molecular weight of from about 20,000 g/mol to about 45,000 g/mol on an absolute polycarbonate molecular weight scale. In an even further aspect, the polycarbonate component has a weight average molecular weight of from about 20,000 g/mol to about 40,000 g/mol on an absolute polycarbonate molecular weight scale. In a still further aspect, the polycarbonate component has a weight average molecular weight of from about 20,000 g/mol to about 35,000 g/mol on an absolute polycarbonate molecular weight scale. In a yet further aspect, the polycarbonate component has a weight average molecular weight of from about 20,000 g/mol to about 30,000 g/mol on an absolute polycarbonate molecular weight scale. In an even further aspect, the polycarbonate component has a weight average molecular weight of from about 20,000 g/mol to about 30,000 g/mol on an absolute polycarbonate molecular weight scale. In a still further aspect, the polycarbonate component has a weight average molecular weight of from about 20,000 g/mol to about 29,000 g/mol on an absolute polycarbonate molecular weight scale.

In one aspect, the polycarbonate component has a weight average molecular weight of from about 25,000 g/mol to about 100,000 g/mol on an absolute polycarbonate molecular weight scale. In a further aspect, the polycarbonate component has a weight average molecular weight of from about 25,000 g/mol to about 50,000 g/mol on an absolute polycarbonate molecular weight scale. In a yet further aspect, the polycarbonate component has a weight average molecular weight of from about 25,000 g/mol to about 45,000 g/mol on an absolute polycarbonate molecular weight scale. In an even further aspect, the polycarbonate component has a weight average molecular weight of from about 25,000 g/mol to about 40,000 g/mol on an absolute polycarbonate molecular weight scale. In a still further aspect, the polycarbonate component has a weight average molecular weight of from about 25,000 g/mol to about 35,000 g/mol on an absolute polycarbonate molecular weight scale. In a yet further aspect, the polycarbonate component has a weight average molecular weight of from about 25,000 g/mol to about 30,000 g/mol on an absolute polycarbonate molecular weight scale. In an even further aspect, the polycarbonate component has a weight average molecular weight of from about 25,000 g/mol to about 30,500 g/mol on an absolute polycarbonate molecular weight scale. In a still further aspect, the polycarbonate component has a weight average molecular weight of from about 25,000 g/mol to about 30,000 g/mol on an absolute polycarbonate molecular weight scale. In a yet further aspect, the polycarbonate component has a weight average molecular weight of from about 25,000 g/mol to about 29,000 g/mol on an absolute polycarbonate molecular weight scale.

In one aspect, the polycarbonate component has a weight average molecular weight of from about 18,000 g/mol to about 35,000 g/mol on an absolute polycarbonate molecular weight scale. In a further aspect, the polycarbonate component has a weight average molecular weight of from about 18,000 g/mol to about 30,000 g/mol on an absolute polycarbonate molecular weight scale. In an even further aspect, the polycarbonate component has a weight average molecular weight of from about 18,000 g/mol to about 25,000 g/mol on an absolute polycarbonate molecular weight scale. In a still further aspect, the polycarbonate component has a weight average molecular weight of from about 18,000 g/mol to about 23,000 g/mol on an absolute polycarbonate molecular weight scale.

In one aspect, the polycarbonate polymer component is a low flow polycarbonate. In another aspect, the polycarbonate polymer component has a melt volume flow rate (MFR) of at least about 3.0 grams/10 minutes when measured at 300° C. and under a load of 1.2 kg according to ASTM D1238. In still another aspect, the polycarbonate polymer component has a melt volume flow rate (MFR) of at least about 4.0 grams/10 minutes when measured at 300° C. and under a load of 1.2 kg according to ASTM D1238. In still another aspect, the polycarbonate polymer component has a melt volume flow rate (MFR) of at least about 4.5 grams/10 minutes when measured at 300° C. and under a load of 1.2 kg according to ASTM D1238. In still another aspect, the polycarbonate polymer component has a melt volume flow rate (MFR) of at least about 5.0 grams/10 minutes when measured at 300° C. and under a load of 1.2 kg according to ASTM D1238. In still another aspect, the polycarbonate polymer component has a melt volume flow rate (MFR) of at least about 5.1 grams/10 minutes when measured at 300° C. and under a load of 1.2 kg according to ASTM D1238. In still another aspect, the polycarbonate polymer component has a melt volume flow rate (MFR) of at least about 5.2 grams/10 minutes when measured at 300° C. and under a load of 1.2 kg according to ASTM D1238. In still another aspect, the polycarbonate polymer component has a melt volume flow rate (MFR) from about 4.0 grams/10 minutes to about 8.0 grams/10 minutes when measured at 300° C. and under a load of 1.2 kg according to ASTM D1238. In still another aspect, the polycarbonate polymer component has a melt volume flow rate (MFR) from about 4.5 grams/10 minutes to about 7.2 grams/10 minutes when measured at 300° C. and under a load of 1.2 kg according to ASTM D1238. In still another aspect, the polycarbonate polymer component has a melt volume flow rate (MFR) from about 4.8 grams/10 minutes to about 7.1 grams/10 minutes when measured at 300° C. and under a load of 1.2 kg according to ASTM D1238. In still another aspect, the polycarbonate polymer component has a melt volume flow rate (MFR) from about 5.1 grams/10 minutes to about 6.9 grams/10 minutes when measured at 300° C. and under a load of 1.2 kg according to ASTM D1238.

### Zinc Additive Component

In one aspect, the disclosed thermoplastic compositions with antimicrobial properties of the present invention comprise zinc additives. In a further aspect, the disclosed thermoplastic compositions comprise one or more zinc additives. In a still further aspect, the disclosed thermoplastic compositions comprise at least one zinc additive. In a yet further aspect, the zinc additive component comprises a zinc-coated carrier.

In further aspects, the zinc additive component comprises zinc, zinc oxide, zinc acetate, zinc stearate, zinc carbonate, zinc nitrate, or a salt thereof, or a combination thereof. In some aspects, the zinc additive component is zinc oxide.

In further aspects, the zinc additive component comprises any desired shape or form. In some aspects, the zinc additive component is a solid additive blended with the thermoplastic component. In other aspects, the zinc additive component is an aqueous solution. In further aspects, the zinc additive component is in small spherical particles. In one aspect, the zinc additive component comprises nanoparticles.

In further aspects, the zinc additive component comprises zinc-based nanoparticles dispersed in a carrier. In some aspects, the nanoparticles are dispersed in a polymeric carrier. In other aspects, the nanoparticles are dispersed in a non-polymeric carrier, such as for example, pentaerythritol tetrastearate (PETS), and the like.

In further aspects, the carrier can comprise a waxy matrix carrier material. In still further aspects, the waxy material has a melting point of at least about 40° C. In yet further aspects, the waxy material can be natural, synthetic, or modified natural waxes, or a combination thereof. In even further aspects, the waxy material can comprise a polyethylene wax, oxidized polyethylene wax, amide wax, ester wax, or hydrogenated oil, or combinations thereof. In one aspect, an example of an exemplary zinc additive component can include, for example, zinc oxide R8243, available from Holland Colors (HCA).

In further aspects, the zinc additive component can have any desired wt % zinc content. In still further aspects, the zinc content of the zinc additive component is in amount in the range of from greater than 0 to 100 wt % relative to the total weight of the zinc additive component. In yet further aspects, the zinc content of the zinc additive component is in amount in the range of from greater than 0 to 75 wt % relative to the total weight of the zinc additive component. In even further aspects, the zinc content of the zinc additive component is in amount in the range of from greater than 0 to 50 wt % relative to the total weight of the zinc additive component. In still further aspects, the zinc content of the zinc additive component is in amount in the range of from greater than 0 to 25 wt % relative to the total weight of the zinc additive component.

In further aspects, the zinc additive component can be present in the composition in any desired amount. In still further aspects, the zinc additive component is present in the composition in an amount in the range of from greater than 0 to 5 wt % relative to the total weight of the composition. In yet further aspects, the zinc additive component is present in the composition in an amount in the range of from greater than 0 to 4 wt % relative to the total weight of the composition. In even further aspects, the zinc additive component is present in the composition in an amount in the range of from greater than 0 to 3 wt % relative to the total weight of the composition. In still further aspects, the zinc additive component is present in the composition in an amount in the range of from greater than 0 to 2 wt % relative to the total weight of the composition.

### Acid Stabilizer Component

In one aspect, the disclosed thermoplastic compositions with antimicrobial properties of the present invention comprise acid stabilizers. In a further aspect, the disclosed thermoplastic compositions comprise one or more acid stabilizers. In a still further aspect, the disclosed thermoplastic compositions comprise at least one acid stabilizer. In various aspects, the acid stabilizer component can prevent molecular weight degradation that may be caused by the zinc additive component.

In further aspects, the acid stabilizer is selected from phosphorous acid, phosphoric acid, mono zinc phosphate, mono sodium phosphate, or sodium acid pyrophosphate, or a combination thereof. In still further aspects, the acid stabilizer component is phosphorous acid.

In various aspects, the acid stabilizer component can be present in the composition in any desired amount. In one aspect, the acid stabilizer component is present in the composition in an amount in the range of from greater than 0 to 5 wt % relative to the total weight of the composition. In further aspects, the acid stabilizer component is present in the composition in an amount in the range of from greater than 0 to 4 wt % relative to the total weight of the composition. In still further aspects, the acid stabilizer component is present in the composition in an amount in the range of from greater than 0 to 3 wt % relative to the total weight of the composition. In yet further aspects, the acid stabilizer component is present in the composition in an amount in the range of from greater than 0 to 2 wt % relative to the total weight of the composition. In even further aspects, the acid stabilizer component is present in the composition in an amount in the range of from greater than 0 to 1 wt % relative to the total weight of the composition.

### Other Additives for Thermoplastic Compositions

In one aspect, the disclosed thermoplastic compositions with antimicrobial properties of the present invention can comprise impact modifiers. In a further aspect, the disclosed thermoplastic compositions comprise one or more impact modifiers. In a still further aspect, the disclosed thermoplastic compositions comprise at least one impact modifier. In a yet further aspect, the disclosed thermoplastic compositions comprise two impact modifiers, that is, a first impact modifier component and a second impact modifier component.

In a further aspect, the impact modifier of the present invention is selected from an acrylonitrile-butadiene-styrene polymer (ABS), a methyl methacrylate-acrylonitrile-butadiene-styrene (MABS) polymer and a methyl methacrylate-butadiene-styrene (MBS) polymer. In a still further aspect, the impact modifier is an acrylonitrile-butadiene-styrene polymer (“ABS polymer”).

Acrylonitrile-butadiene-styrene (“ABS”) graft copolymers contain two or more polymeric parts of different compositions, which are bonded chemically. The graft copolymer is specifically prepared by first polymerizing a conjugated diene, such as butadiene or another conjugated diene, with a monomer copolymerizable therewith, such as styrene, to provide a polymeric backbone. After formation of the polymeric backbone, at least one grafting monomer, and specifically two, are polymerized in the presence of the polymer backbone to obtain the graft copolymer. These resins are prepared by methods well known in the art.

For example, ABS can be made by one or more of emulsion or solution polymerization processes, bulk/mass, suspension and/or emulsion-suspension process routes. In addition, ABS materials can be produced by other process techniques such as batch, semi batch and continuous polymerization for reasons of either manufacturing economics or product performance or both. In order to reduce point defects or inclusions in the inner layer of the final multi-layer article, the ABS is produced by bulk polymerized.

Emulsion polymerization of vinyl monomers gives rise to a family of addition polymers. In many instances the vinyl emulsion polymers are copolymers containing both rubbery and rigid polymer units. Mixtures of emulsion resins, especially mixtures of rubber and rigid vinyl emulsion derived polymers are useful in blends.

Exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), methacrylate-butadiene (MB) and styrene-acrylonitrile (SAN).

In a further aspect, the impact modifier component comprises one more of an acrylonitrile butadiene styrene (“ABS”) copolymer, a methacrylate butadiene styrene (“MBS”) copolymer, and a bulk polymerized ABS (“BABS”) copolymer. In a still further aspect, the impact modifier component comprises an acrylonitrile butadiene styrene (“ABS”) copolymer. In a yet further aspect, the impact modifier component comprises a methacrylate butadiene styrene (“MBS”) copolymer. In an even further aspect, the impact modifier component comprises a bulk polymerized ABS (“BABS”) copolymer.

In a further aspect, the impact modifier component is present in an amount from about 2 wt % to about 10 wt %. In a still further aspect, the impact modifier component is present in an amount from about 4 wt % to about 8 wt %. In a yet further aspect, the impact modifier component is present in an amount from about 4 wt % to about 6 wt %. In an even further aspect, the impact modifier component is present in an amount from about 2 wt % to about 9 wt %. In a still further aspect, the impact modifier component is present in an amount from about 1 wt % to about 6 wt %. In a yet further aspect, the impact modifier component is present in an amount from about 2 wt % to about 5 wt %. In an even further aspect, the impact modifier component is present in an amount from about 2 wt % to about 4 wt %.

In addition to the foregoing components, the disclosed thermoplastic compositions can optionally comprise a balance amount of one or more additive materials ordinarily incorporated in thermoplastic polymer compositions of this type, with the proviso that the additives are selected so as to not significantly adversely affect the desired properties of the polycarbonate composition. Combinations of additives can be used. Such additives can be mixed at a suitable time during the mixing of the components for forming the composition. Exemplary and non-limiting examples of additive materials that can be present in the disclosed polycarbonate compositions include an antioxidant, a stabilizer (including for example a thermal stabilizer, a hydrolytic stabilizer, or a light stabilizer), UV absorbing additive, plasticizer, lubricant, mold release agent, antistatic agent, colorant (e.g., pigment and/or dye), or any combination thereof.

In a further aspect, the disclosed polycarbonate blend compositions can further comprise a primary antioxidant or “stabilizer” (e.g., a hindered phenol) and, optionally, a secondary antioxidant (e.g., a phosphate and/or thioester). Suitable antioxidant additives include, for example, organic phosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

Antioxidants are generally used in amounts of about 0.01 wt % to about 1 wt %, optionally about 0.05 wt % to about 0.5 wt % of the thermoplastic blend composition. In one aspect, the primary antioxidant is present in an amount from about 0.1 wt % to about 1 wt %. In another aspect, the primary antioxidant is present in an amount from about 0.1 wt % to about 0.9 wt %. In still another aspect, the primary antioxidant is present in an amount from about 0.1 wt % to about 0.7 wt %. In still another aspect, the primary antioxidant is present in an amount from about 0.1 wt % to about 0.5 wt %. In still another aspect, the primary antioxidant is present in an amount from about 0.2 wt % to about 0.5 wt %. In still another aspect, the primary antioxidant is present in an amount from about 0.2 wt % to about 0.4 wt %.

In one aspect, the secondary antioxidant is present in an amount from about 0.01 wt % to about 1 wt %. In another aspect, the secondary antioxidant is present in an amount from about 0.05 wt % to about 0.8 wt %. In still another aspect, the secondary antioxidant is present in an amount from about 0.05 wt % to about 0.6 wt %. In still another aspect, wherein the secondary antioxidant is present in an amount from about 0.05 wt % to about 0.4 wt %. In still another aspect, the secondary antioxidant is present in an amount from about 0.05 wt % to about 0.2 wt %.

In various aspects, the disclosed thermoplstic blend composition further comprises a hydrolytic stabilizer, wherein the hydrolytic stabilizer comprises a hydrotalcite and an inorganic buffer salt. In a further aspect, the disclosed thermoplastic blend composition comprises a hydrolytic stabilizer, wherein the hydrolytic stabilizer comprises one or more hydrotalcites and an inorganic buffer salt comprising one or more inorganic salts capable of pH buffering. Either synthetic hydrotalcites or natural hydrotalcites can be used as the hydrotalcite compound in the present invention. Exemplary hydrotalcites that are useful in the compositions of the present are commercially available and include, but are not limited to, magnesium hydrotalcites such as DHT-4C (available from Kyowa Chemical Co.); Hysafe 539 and Hysafe 530 (available from J.M. Huber Corporation).

In a further aspect, suitable thermal stabilizer additives include, for example, organic phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, organic phosphates such as trimethyl phosphate, thioesters such as pentaerythritol betalaurylthiopropionate, and the like, or combinations comprising at least one of the foregoing thermal stabilizers.

Thermal stabilizers are generally used in amounts of about 0.01 wt % to about 5 wt %, optionally about 0.05 wt % to about 0.3 wt % of the thermoplstic composition. In one aspect, the thermal stabilizer is present in an amount from about 0.05 wt % to about 1.0 wt %. In another aspect, the thermal stabilizer is present in an amount from about 0.1 wt % to about 1.0 wt %. In still another aspect, the thermal stabilizer is present in an amount from about 0.1 wt % to about 0.9 wt %. In still another aspect, the thermal stabilizer is present in an amount from about 0.05 wt % to about 1.0 wt %. In still another aspect, the thermal stabilizer is present in an amount from about 0.1 wt % to about 0.8 wt %. In still another aspect, the thermal stabilizer is present in an amount from about 0.1 wt % to about 0.7 wt %. In still another aspect, the thermal stabilizer is present in an amount from about 0.1 wt % to about 0.6 wt %. In still another aspect, the thermal stabilizer is present in an amount from about 0.1 wt % to about 0.5 wt %. In still another aspect, the thermal stabilizer is present in an amount from about 0.1 wt % to about 0.4 wt %. In still another aspect, the thermal stabilizer is present in an amount from about 0.05 wt % to about 1.0 wt %.

In a further aspect, light stabilizers and/or ultraviolet light (UV) absorbing additives can also be used. Suitable light stabilizer additives include, for example, benzotriazoles such as 2-(2-hydroxy-5-methylphenyl)benzotriazole, 2-(2-hydroxy-5-tert-octylphenyl)-benzotriazole and benzophenones such as 2-hydroxy-4-n-octoxy benzophenone, or the like, or combinations comprising at least one of the foregoing light stabilizers. Light stabilizers are generally used in amounts of about 0.01 wt % to about 10 wt %, optionally about 0.1 wt % to about 1 wt % of the thermoplstic blend composition.

In a further aspect, suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenyl-acryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane; nano-size inorganic materials such as titanium oxide, cerium oxide, and zinc oxide, all with particle size less than about 100 nanometers; or the like, or combinations comprising at least one of the foregoing UV absorbers. UV absorbers are generally used in amounts of about 0.1 wt % to about 5 wt % of the thermoplstic blend composition.

In various aspects, plasticizers, lubricants, and/or mold release agents additives can also be used. There is a considerable overlap among these types of materials, which include, for example, di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as medium and high molecular weight alkyl stearyl esters; mixtures of fatty acid esters and hydrophilic and hydrophobic nonionic surfactants comprising polyethylene glycol polymers, polypropylene glycol polymers, and copolymers thereof; waxes such as beeswax, montan wax, paraffin wax or the like.

Such materials are generally used in amounts of about 0.1 wt % to about 20 wt %, optionally about 1 wt % to about 10 wt % the thermoplastic blend composition. In one aspect, the mold release agent is methyl stearate; stearyl stearate or pentaerythritol tetrastearate. In another aspect, the mold release agent is pentaerythritol tetrastearate.

In one aspect, the mold release agent is present in an amount from about 0.1 wt % to about 1.0 wt %. In another aspect, the mold release agent is present in an amount from about 0.1 wt % to about 0.9 wt %. In still another aspect, the mold release agent is present in an amount from about 0.1 wt % to about 0.8 wt %. In still another aspect, the mold release agent is present in an amount from about 0.1 wt % to about 0.7 wt %. In still another aspect, the mold release agent is present in an amount from about 0.1 wt % to about 0.6 wt %. In still another aspect, the mold release agent is present in an amount from about 0.1 wt % to about 0.5 wt %.

In a further aspect, colorants such as pigment and/or dye additives can also be present. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments. Pigments are generally used in amounts of about 0.01 wt % to about 10 wt %, the polycarbonate blend composition.

In one aspect, the pigment is selected from titanium dioxide, zinc sulfide, carbon black, cobalt chromate, cobalt titanate, cadmium sulfides, iron oxide, sodium aluminum sulfosilicate, sodium sulfosilicate, chrome antimony titanium rutile, nickel antimony titanium rutile, and zinc oxide. In another aspect, the pigment is carbon black.

In one aspect, the pigment is present in an amount from about 0.01 wt % to about 1 wt %. In another aspect, the pigment is present in an amount from about 0.1 wt % to about 0.9 wt %. In still another aspect, the pigment is present in an amount from about 0.2 wt % to about 0.8 wt %. In still another aspect, the pigment is present in an amount from about 0.2 wt % to about 0.7 wt %. In still another aspect, the pigment is present in an amount from about 0.3 wt % to about 0.6 wt %. In still another aspect, the pigment is present in an amount of about 0.5 wt %.

In a further aspect, suitable dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″,5″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene; chrysene; rubrene; coronene, or the like, or amounts of about 0.1 to about 10 ppm.

In a further aspect, the anti-drip agents can also be present. Exemplary anti-drip agents can include a fibril forming or non-fibril forming fluoropolymer such as polytetrafluoroethylene (PTFE). The anti-drip agent can optionally be encapsulated by a rigid copolymer, for example styrene-acrylonitrile (SAN). PTFE encapsulated in SAN is known as TSAN. Encapsulated fluoropolymers can be made by polymerizing the encapsulating polymer in the presence of the fluoropolymer, for example, in an aqueous dispersion. TSAN can provide significant advantages over PTFE, in that TSAN can be more readily dispersed in the composition. A suitable TSAN can comprise, for example, about 50 wt % PTFE and about 50 wt % SAN, based on the total weight of the encapsulated fluoropolymer. Alternatively, the fluoropolymer can be pre-blended in some manner with a second polymer, such as for, example, an aromatic polycarbonate resin or SAN to form an agglomerated material for use as an anti-drip agent. Either method can be used to produce an encapsulated fluoropolymer.

In a further aspect, the thermoplastic compositions further comprise a flame retardant selected from a chlorine-containing hydrocarbon, a bromine-containing hydrocarbon, boron compound, a metal oxide, antimony oxide, aluminum hydroxide, a molybdenum compound, zinc oxide, magnesium oxide, an organic phosphate, phosphinate, phosphite, phosphonate, phosphene, halogenated phosphorus compound, inorganic phosphorus containing salt, and a nitrogen-containing compound, or a combination comprising at least one of the foregoing. In a still further aspect, the flame retardant is a phosphorus-containing flame retardant. In a yet further aspect, the phosphorus-containing flame retardant is selected from resorcinol bis(biphenyl phosphate), bisphenol A bis(diphenyl phosphate), and hydroquinone bis(diphenyl phosphate), or mixtures thereof.

### Thermoplastic Composition Properties

In various aspects, the thermoplastic compositions of the present invention exhibit antimicrobial properties. In further aspects, molded parts formed from the thermoplastic composition of the present invention also exhibit antimicrobial properties. In still further aspects, a molded part formed from the thermoplastic composition exhibits greater antimicrobial activity compared to a molded part formed from an identical reference composition comprising the same thermoplastic component, and the same weight percentage of the same acid stabilizer component, but in the absence of the zinc additive component.

In some aspects, the antimicrobial properties are microbiostatic activity. In other aspects, the antimicrobial properties are bacteriostatic activity. In further aspects, the antimicrobial properties are fungistatic activity.

Thus, according to aspects of the disclosure, a molded part formed from the thermoplastic composition exhibits greater microbiostatic activity compared to a molded part formed from an identical reference composition comprising the same thermoplastic component, and the same weight percentage of the same acid stabilizer component, but in the absence of the zinc additive component. In further aspects, a molded part formed from the thermoplastic composition exhibits greater bacteriostatic activity compared to a molded part formed from an identical reference composition comprising the same thermoplastic component, and the same weight percentage of the same acid stabilizer component, but in the absence of the zinc additive component. In still further aspects, a molded part formed from the thermoplastic composition exhibits greater fungistatic activity compared to a molded part formed from an identical reference composition comprising the same thermoplastic component, and the same weight percentage of the same acid stabilizer component, but in the absence of the zinc additive component.

In various aspects, the disclosed thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component. In further aspects, a molded part formed from the thermoplastic composition exhibits a microorganism logarithmic reduction (log R) of at least 1.0 as determined according to JIS Z 2801. In still further aspects, a molded part formed from the thermoplastic composition exhibits a microorganism logarithmic reduction (log R) of at least 1.5 as determined according to JIS Z 2801. In yet further aspects, a molded part formed from the thermoplastic composition exhibits a microorganism logarithmic reduction (log R) of at least 2.0 as determined according to JIS Z 2801.

In further aspects, the disclosed thermoplastic composition exhibits a lower microorganism colony forming unit (CFU) value as determined according to JIS Z 2801, compared to a molded part formed from an identical reference composition comprising the same thermoplastic component, and the same weight percentage of the same acid stabilizer component, but in the absence of the zinc additive component.

In various aspects, the disclosed thermoplastic compositions exhibit antimicrobial activity against various microorganisms. In some aspects, the microorganism is bacterial, or fungal, or a combination thereof. In other aspects, the microorganism is staphylococcus aureus. In further aspects, the microorganism is methicillin-resistant staphylococcus aureus (MRSA).

In various aspects, the disclosed antimicrobial thermoplastic compositions are transparent and exhibit superior optical properties. In some aspects, the disclosed thermoplastic compositions exhibit a transmission of at least about 85% as determined according to ASTM D1003. In further aspects, the disclosed thermoplastic compositions exhibit a transmission of at least about 87% as determined according to ASTM D1003. In still further aspects, the disclosed thermoplastic compositions exhibit a transmission of at least about 90% as determined according to ASTM D1003. In yet further aspects, the transmission can be in a range derived from any two of the above listed exemplary values. For example, the transmission can be in the range of from greater than 85% to 91%.

In other aspects, the disclosed thermoplastic compositions exhibit haze of no greater than 16 as determined according to ASTM D1003. In further aspects, the disclosed thermoplastic compositions exhibit haze of no greater than 12 as determined according to ASTM D1003. In still further aspects, the disclosed thermoplastic compositions exhibit haze of no greater than 8 as determined according to ASTM D1003. In yet further aspects, the disclosed thermoplastic compositions exhibit haze of no greater than 5 as determined according to ASTM D1003. In even further aspects, the disclosed thermoplastic compositions exhibit haze of no greater than 2 as determined according to ASTM D1003. In still further aspects, the haze can be in a range derived from any two of the above listed exemplary values. For example, the haze can be in the range of from greater than 0 to 9.

### Methods of Improving Thermoplastic Composition Properties

In various aspects, the invention pertains to methods for improving antimicrobial properties of a thermoplastic composition, the method comprising: combining:

a) a thermoplastic polymer component;

b) a zinc additive component; and

c) an acid stabilizer component;

wherein a molded part formed from the thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component.

In other aspects, the invention pertains to methods for inhibiting microorganism growth on a thermoplastic composition, the method comprising: combining:

a) a thermoplastic polymer component;

b) a zinc additive component; and

c) an acid stabilizer component;

wherein after a 24 hour incubation, a molded part formed from the thermoplastic composition exhibits a lower microorganism colony forming unit (CFU) value as determined according to JIS Z 2801, compared to a molded part formed from an identical reference composition comprising the same thermoplastic component, and the same weight percentage of the same acid stabilizer component, but in the absence of the zinc additive component.

In other aspects, the invention pertains to methods for inhibiting microorganism biofilm on a thermoplastic composition, the method comprising: combining:

a) a thermoplastic polymer component;

b) a zinc additive component; and

c) an acid stabilizer component;

wherein after a 24 hour incubation, a molded part formed from the thermoplastic composition exhibits a lower microorganism biofilm formation, compared to a molded part formed from an identical reference composition comprising the same thermoplastic component, and the same weight percentage of the same acid stabilizer component, but in the absence of the zinc additive component.

Thus, according to aspects of the disclosure, the present methods and compositions can impair microorganism growth by inhibiting microorganism colonization or attachment on the surfaces of articles comprised of the disclosed thermoplastic compositions.

In further aspects, the invention pertains to methods for inhibiting molecular weight degradation in antimicrobial thermoplastic composition, the method comprising: combining:

a) a thermoplastic polymer component;

b) a zinc additive component; and

c) an acid stabilizer component;

wherein the thermoplastic composition exhibits a higher molecular weight, compared to an identical reference thermoplastic composition comprising the same thermoplastic component, and the same weight percentage of the same zinc additive component, but in the absence of the acid stabilizer component.

### Manufacture of Thermoplastic Compositions

In various aspects, the thermoplastic compositions of the present invention can be manufactured by various methods. The compositions of the present invention can be blended with the aforementioned ingredients by a variety of methods involving intimate admixing of the materials with any additional additives desired in the formulation. Because of the availability of melt blending equipment in commercial polymer processing facilities, melt processing methods can be used. In various further aspects, the equipment used in such melt processing methods includes, but is not limited to, the following: co-rotating and counter-rotating extruders, single screw extruders, co-kneaders, disc-pack processors and various other types of extrusion equipment. In a further aspect, the extruder is a twin-screw extruder. In various further aspects, the melt processed composition exits processing equipment such as an extruder through small exit holes in a die. The resulting strands of molten resin are cooled by passing the strands through a water bath. The cooled strands can be chopped into small pellets for packaging and further handling.

The temperature of the melt is minimized in order to avoid excessive degradation of the resins. For example, it can be desirable to maintain the melt temperature between about 230° C. and about 350° C. in the molten resin composition, although higher temperatures can be used provided that the residence time of the resin in the processing equipment is kept short. In a still further aspect, the extruder is typically operated at a temperature of about 180° C. to about 385° C. In a yet further aspect, the extruder is typically operated at a temperature of about 200° C. to about 330° C. In an even further aspect, the extruder is typically operated at a temperature of about 220° C. to about 300° C.

In various aspects, the thermoplastic compositions of the present invention can be prepared by blending the polycarbonate, impact modifier, poly(alkylene ester), and filler components in mixer, e.g. a HENSCHEL-Mixer® high speed mixer or other suitable mixer/blender. Other low shear processes, including but not limited to hand mixing, can also accomplish this blending. The mixture can then be fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch desired polymeric resin and fed into the extruder. The extruder generally operated at a temperature higher than that necessary to cause the composition to flow. The extrudate is immediately quenched in a water bath and pelletized. The pellets, so prepared, when cutting the extrudate can be one-fourth inch long or less as desired. Such pellets can be used for subsequent molding, shaping, or forming.

Thus, according to aspects of the disclosure, the invention provides a method for forming an antimicrobial thermoplastic blend comprising, combining: a) a thermoplastic polymer component comprising a polycarbonate, polyalkylene terephthalate, polypropylene (PP), polyphenylene oxide (PPO), polyetherimide (PEI), or a combination thereof; b) a zinc additive component; and c) an acid stabilizer component.

### Articles of Manufacture

In various aspects, the disclosed thermoplastic compositions with antimicrobial properties of the present invention can be used in making articles. The disclosed thermoplastic compositions can be formed into useful shaped articles by a variety of means such as; injection molding, extrusion, rotational molding, compression molding, blow molding, sheet or film extrusion, profile extrusion, gas assist molding, structural foam molding and thermoforming. The thermoplastic compositions described herein resins can also be made into film and sheet as well as components of laminate systems. In a further aspect, in an embodiment, a method of manufacturing an article comprises melt blending the thermoplastic polymer component, the zinc additive component, and the acid stabilizer component; and molding the extruded composition into an article. In a still further aspect, the extruding is done with a twin-screw extruder.

In various aspects, the invention pertains to articles comprising the disclosed compositions. In a yet further aspect, the article is used in medical applications. In a still further aspect, the article is used in automotive applications. In an even further aspect, the article is selected from a body panel, an instrument panel, a surgical cart, a tool or equipment housing, a medical device, or a toy.

Formed articles include, for example, computer and business machine housings, home appliances, trays, plates, handles, device parts such as instrument panels, holders, exterior and interior coverings and the like. In various further aspects, formed articles include, but are not limited to, food service items, medical devices, animal cages, electrical connectors, enclosures for electrical equipment, electric motor parts, power distribution equipment, communication equipment, computers and the like. Suitable articles are exemplified by enclosures, housings, panels, enclosures for electrical and telecommunication devices; wall panels, and doors; outdoor and indoor signs; enclosures, housings, panels, and parts for automatic teller machines (ATM); window and door trim; sports equipment and toys; playground equipment; computer housings; desk-top computer housings; portable computer housings; lap-top computer housings; palm-held computer housings; monitor housings; printer housings; keyboards; facsimile machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; and like applications.

In one aspect, the present invention pertains to medical devices comprising the disclosed thermoplastic compositions. In a further aspect, the medical device comprising the disclosed thermoplastic compositions is a surgical device, imaging device, monitoring device, blood care device, or drug delivery device. In other aspects, the present invention pertains to parts for building and construction applications such as, for example, interior trim, windows, floors, decorative window furnishings or treatments; covers for pictures, paintings, posters, and like display items; wall panels, and doors; protected graphics; outdoor and indoor signs; enclosures, housings, panels, lighting enclosures, housings, panels, switches and covers; bedding parts; furniture parts; and the like.

### Aspects

In various aspects, the present invention pertains to and includes at least the following aspects.

Aspect 1: Aspect 1:A thermoplastic composition comprising: a. a thermoplastic polymer component comprising a polycarbonate, polyalkylene terephthalate, polypropylene (PP), polyphenylene oxide (PPO), polyetherimide (PEI), or a combination thereof; b. a zinc additive component; and c. an acid stabilizer component.

Aspect 2: The thermoplastic composition of aspect 1, comprising: a. from greater than 0 wt % to less than 100 wt % of a thermoplastic polymer component comprising a polycarbonate, polyalkylene terephthalate, polypropylene (PP), polyphenylene oxide (PPO), polyetherimide (PEI), or a combination thereof; b. from greater than 0 wt % to about 10 wt % of a zinc additive component; and c. from greater than 0 wt % to about 5 wt % of an acid stabilizer component.

Aspect 3: The thermoplastic composition of aspect 1 or 2, wherein the thermoplastic polymer component comprises at least one polycarbonate.

Aspect 4: The thermoplastic composition of any of aspects 1-3, wherein the thermoplastic polymer component is present in an amount in the range of from greater than 0 to 99 wt % relative to the total weight of the composition.

Aspect 5: The thermoplastic composition of any of aspects 1-4, wherein the thermoplastic polymer is present in an amount in the range of from greater than 0 to 95 wt % relative to the total weight of the composition.

Aspect 6: The thermoplastic composition of any of aspects 1-5, wherein the zinc additive component comprises zinc, zinc oxide, zinc acetate, zinc stearate, zinc carbonate, zinc nitrate, or a salt thereof, or a combination thereof.

Aspect 7: The thermoplastic composition of any of aspects 1-6, wherein the zinc additive component contained in the polymer matrix is zinc oxide.

Aspect 8: The thermoplastic composition of any of aspects 1-7, wherein the zinc additive component is present in the composition in an amount in the range of from greater than 0 to 5 wt % relative to the total weight of the composition.

Aspect 9: The thermoplastic composition of any of aspects 1-8, wherein the zinc additive component is present in the composition in an amount in the range of from greater than 0 to 2 wt % relative to the total weight of the composition.

Aspect 10: The thermoplastic composition of any of aspects 1-9, wherein the acid stabilizer is selected from phosphorous acid, phosphoric acid, mono zinc phosphate, mono sodium phosphate, or sodium acid pyrophosphate, or a combination thereof.

Aspect 11: The thermoplastic composition of any of aspects 1-10, wherein the acid stabilizer component is phosphorous acid.

Aspect 12: The thermoplastic composition of any of aspects 1-11, wherein the acid stabilizer component is present in the composition in an amount in the range of from greater than 0 to 5 wt % relative to the total weight of the composition.

Aspect 13: The thermoplastic composition of any of aspects 1-12, wherein the acid stabilizer component is present in the composition in an amount in the range of from greater than 0 to 2 wt % relative to the total weight of the composition.

Aspect 14: The thermoplastic composition of any aspects 1-12, further comprising an additive selected from thermal stabilizer, UV stabilizer, primary anti-oxidant, secondary anti-oxidant, mold release agent, lubricant, flame retardant agent, smoke suppressor agent, buffer, acid scavenger, hydrolytic stabilizer, quencher, pigment, and combinations of two or more of the foregoing.

Aspect 15: The thermoplastic composition of aspect 14, wherein the primary antioxidant is selected from hindered phenols, phosphites, phosphonates, and a combination thereof.

Aspect 16: The thermoplastic composition of aspect 15, wherein the hindered phenol is octadecyl 3-(3,5-di-t-butyl-4-hydroxyphenyl)propionate.

Aspect 17: The thermoplastic composition of aspect 14, wherein the secondary antioxidant is selected from organophosphates, thioesters, thioethers, and any mixture thereof.

Aspect 18: The thermoplastic composition of aspect 17, wherein the secondary antioxidant is tris(2,4-di-tert-butylphenyl) phosphite.

Aspect 19: The thermoplastic composition of aspect 14, wherein the thermal stabilizer is pentaerythritol tetrakis(3-dodecylthiopropionate).

Aspect 20: The thermoplastic composition of aspect 14, wherein the mold release agent is pentaerythritol tetrastearate.

Aspect 21: The thermoplastic composition of aspect 14, wherein the pigment is selected from titanium dioxide, zinc sulfide, carbon black, cobalt chromate, cobalt titanate, cadmium sulfides, iron oxide, sodium aluminum sulfosilicate, sodium sulfosilicate, chrome antimony titanium rutile, nickel antimony titanium rutile, and zinc oxide.

Aspect 22: The thermoplastic composition according to any preceding aspect, wherein the thermoplastic composition exhibits antimicrobial properties against at least one microorganism.

Aspect 23: The thermoplastic composition according to any preceding aspect, wherein a molded part formed from the thermoplastic composition exhibits antimicrobial properties against at least one microorganism.

Aspect 24: The thermoplastic composition according to any preceding aspect, wherein a molded part formed from the thermoplastic composition exhibits greater antimicrobial activity compared to a molded part formed from an identical reference composition comprising the same thermoplastic component, and the same weight percentage of the same acid stabilizer component, but in the absence of the zinc additive component.

Aspect 25: The thermoplastic composition according to any preceding aspect, wherein the antimicrobial properties are microbiostatic activity.

Aspect 26: The thermoplastic composition according to any preceding aspect, wherein the antimicrobial properties are bacteriostatic activity.

Aspect 27: The thermoplastic composition according to any of aspects 1-26, wherein the antimicrobial properties are fungistatic activity.

Aspect 28: The thermoplastic composition according to any preceding aspect, wherein a molded part formed from the thermoplastic composition exhibits greater bacteriostatic activity compared to a molded part formed from an identical reference composition comprising the same thermoplastic component, and the same weight percentage of the same acid stabilizer component, but in the absence of the zinc additive component.

Aspect 29: The thermoplastic composition according to any preceding aspect, wherein a molded part formed from the thermoplastic composition exhibits a microorganism logarithmic reduction (log R) of at least 1.0 as determined according to JIS Z 2801.

Aspect 30: The thermoplastic composition according to any preceding aspect, wherein a molded part formed from the thermoplastic composition exhibits a microorganism logarithmic reduction (log R) of at least 1.5 as determined according to JIS Z 2801.

Aspect 31: The thermoplastic composition according to any preceding aspect, wherein a molded part formed from the thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component.

Aspect 32: The thermoplastic composition according to any preceding aspect, wherein after a 24 hour incubation, a molded part formed from the thermoplastic composition exhibits a lower microorganism colony forming unit (CFU) value as determined according to JIS Z 2801, compared to a molded part formed from an identical reference composition comprising the same thermoplastic component, and the same weight percentage of the same acid stabilizer component, but in the absence of the zinc additive component.

Aspect 33: The thermoplastic composition according to any preceding aspect, wherein the microorganism is bacterial, or fungal, or a combination thereof.

Aspect 34: The thermoplastic composition according to any preceding aspect, wherein the microorganism is staphylococcus aureus.

Aspect 35: The thermoplastic composition according to any preceding aspect, wherein the microorganism is methicillin-resistant staphylococcus aureus (MRSA).

Aspect 36: A thermoplastic composition, comprising: a. from greater than 0 wt % to about 99 wt % of a thermoplastic polymer component comprising at least one polycarbonate; b. from greater than 0 wt % to about 10 wt % of a zinc additive component comprising zinc, zinc oxide, zinc acetate, zinc stearate, zinc carbonate, zinc nitrate, or a salt thereof, or a combination thereof; and c. from greater than 0 wt % to about 10 wt % of an acid stabilizer component comprising phosphorous acid, phosphoric acid, mono zinc phosphate, mono sodium phosphate, or sodium acid pyrophosphate, or a combination thereof.

Aspect 37: The thermoplastic composition of aspect 36, wherein the zinc additive component is zinc oxide.

Aspect 38: The thermoplastic composition of aspect 36 or 37, wherein the acid stabilizer component is phosphorous acid.

Aspect 39: The thermoplastic composition of any of aspects 36-38, wherein a molded part formed from the thermoplastic composition exhibits greater antimicrobial activity compared to a molded part formed from an identical reference composition comprising the same thermoplastic component, and the same weight percentage of the same acid stabilizer component, but in the absence of the zinc additive component.

Aspect 40: The thermoplastic composition of any of aspects 36-38, wherein a molded part formed from the thermoplastic composition exhibits greater bacteriostatic activity compared to a molded part formed from an identical reference composition comprising the same thermoplastic component, and the same weight percentage of the same acid stabilizer component, but in the absence of the zinc additive component.

Aspect 41: The thermoplastic composition of any of aspects 36-40, wherein a molded part formed from the thermoplastic composition exhibits a microorganism logarithmic reduction (log R) of at least 1.0 as determined according to JIS Z 2801.

Aspect 42: The thermoplastic composition of any of aspects 36-41, wherein a molded part formed from the thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component.

Aspect 43: The thermoplastic composition of any of aspects 36-42, wherein after a 24 hour incubation, a molded part formed from the thermoplastic composition exhibits a lower microorganism colony forming unit (CFU) value as determined according to JIS Z 2801, compared to a molded part formed from an identical reference composition comprising the same thermoplastic component, and the same weight percentage of the same acid stabilizer component, but in the absence of the zinc additive component.

Aspect 44: An article of manufacture comprising the thermoplastic composition according to any of the preceding aspects.

Aspect 45: A method for forming an antimicrobial thermoplastic blend comprising: a. combining: i. a thermoplastic polymer component comprising a polycarbonate, polyalkylene terephthalate, polypropylene (PP), polyphenylene oxide (PPO), polyetherimide (PEI), or a combination thereof; ii. a zinc additive component; and iii. an acid stabilizer component.

Aspect 46: The method according to aspect 45, wherein the step of combining comprises extrusion blending.

Aspect 47: The method according to aspect 45 or 46, further comprising step of molding the thermoplastic polymer blend composition into a molded article.

Aspect 48: The method of according to any of aspects 46-47, wherein the zinc additive component comprises zinc, zinc oxide, zinc acetate, zinc stearate, zinc carbonate, zinc nitrate, or a salt thereof, or a combination thereof.

Aspect 49: The method according to any of aspects 46-48, wherein the acid stabilizer component comprises phosphorous acid, phosphoric acid, mono zinc phosphate, mono sodium phosphate, or sodium acid pyrophosphate, or a combination thereof.

Aspect 50: The method according to any of aspects 45-49, wherein the zinc additive component is zinc oxide.

Aspect 51: The method according to any of aspects 45-50, wherein the acid stabilizer component is phosphorous acid.

Aspect 52: The method of any of aspects 45-51, wherein the thermoplastic polymer component is a polycarbonate.

Aspect 53: The method of any of aspects 45-52, wherein a molded part formed from the thermoplastic composition exhibits greater antimicrobial activity compared to a molded part formed from an identical reference composition comprising the same thermoplastic component, and the same weight percentage of the same acid stabilizer component, but in the absence of the zinc additive component.

Aspect 54: The method of any of aspects 45-53, wherein a molded part formed from the thermoplastic composition exhibits greater bacteriostatic activity compared to a molded part formed from an identical reference composition comprising the same thermoplastic component, and the same weight percentage of the same acid stabilizer component, but in the absence of the zinc additive component.

Aspect 55: The method of any of aspects 45-54, wherein a molded part formed from the thermoplastic composition exhibits a microorganism logarithmic reduction (log R) of at least 1.0 as determined according to JIS Z 2801.

Aspect 56: The method of any of aspects 45-55, wherein a molded part formed from the thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component.

Aspect 57: The method of any of aspects 45-56, wherein after a 24 hour incubation, a molded part formed from the thermoplastic composition exhibits a lower microorganism colony forming unit (CFU) value as determined according to JIS Z 2801, compared to a molded part formed from an identical reference composition comprising the same thermoplastic component, and the same weight percentage of the same acid stabilizer component, but in the absence of the zinc additive component.

Aspect 58: A method for preparing a thermoplastic composition with bacteriostatic properties, the method comprising: a. combining: i. a thermoplastic polymer component; ii. a zinc additive component; and iii. an acid stabilizer component; wherein a molded part formed from the thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component.

Aspect 59: A method of improving antimicrobial properties of a thermoplastic composition, the method comprising: a. combining: i. a thermoplastic polymer component; ii. a zinc additive component; and iii. an acid stabilizer component; wherein a molded part formed from the thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component.

Aspect 60: A method of inhibiting microorganism growth on a thermoplastic composition, the method comprising: a. combining: i. a thermoplastic polymer component; ii. a zinc additive component; and iii. an acid stabilizer component; wherein after a 24 hour incubation, a molded part formed from the thermoplastic composition exhibits a lower microorganism colony forming unit (CFU) value as determined according to JIS Z 2801, compared to a molded part formed from an identical reference composition comprising the same thermoplastic component, and the same weight percentage of the same acid stabilizer component, but in the absence of the zinc additive component.

Aspect 61: A method for inhibiting molecular weight degradation in antimicrobial thermoplastic composition, the method comprising: a. combining: i. a thermoplastic polymer component; ii. a zinc additive component; and iii. an acid stabilizer component; wherein the thermoplastic composition exhibits a higher molecular weight, compared to an identical reference thermoplastic composition comprising the same thermoplastic component, and the same weight percentage of the same zinc additive component, but in the absence of the acid stabilizer component.

Aspect 62: The article of aspect 44, wherein the article is a medical device, surgical device, imaging device, monitoring device, blood care device, or drug delivery device, or a combination thereof.

Aspect 63: The article of aspect 44, wherein the article is interior trim, windows, floors, covers, wall panels, doors, enclosures, housings, panels, lighting switches bedding part, or furniture parts, or combination thereof.

Aspect 64: The article of aspect 44, wherein the article is a culinary device, food preparation device, food storage device, or food delivery device, or a combination thereof.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only routine experimentation, if any, will be required to optimize such process conditions.

The materials shown in Table 1 were used to prepare the various compositions described herein. A range of 0.05-4.8 wt % of zinc additive was compounded with polycarbonate.

TABLE 1

| Identifier | Description | CAS # | Source |
|---|---|---|---|
| PC 105 | Bisphenol A polycarbonate resin made | — | SABIC |
| | by interfacial polymerization with a | | Innovative |
| | weight average molecular weight (M_{w}) | | Plastics |
| | of about 29,000 to 31,000 g/mol relative | | |
| | to polystyrene standards, and MFR at | | |
| | 300° C./1.2 kg, of about 23.5 to about | | |
| | 28.5 g/10 min. | | |
| Zinc oxide | Nano ZnO particles dispersed in non- | 1314-13-2 | Holland Colors |
| R8243 | polymeric carrier (wax) and isolated in | | (HCA) |
| | small spherical particles. ZnO | | |
| | concentration ~44 wt %. | | |
| Zinc oxide | Nano ZnO particles dispersed in non- | 1314-13-2 | Holland Colors |
| R8166 | polymeric carrier (wax) and isolated in | | (HCA) |
| | small spherical particles. ZnO | | |
| | concentration ~25 wt %. | | |
| Zinc oxide | Nano ZnO particles dispersed in non- | 1314-13-2 | Holland Colors |
| R8366 | polymeric carrier (wax) and isolated in | | (HCA) |
| | small spherical particles. ZnO | | |
| | concentration ~25 wt %. | | |
| Zinc oxide | Nano ZnO particles dispersed in non- | 1314-13-2 | Holland Colors |
| R8367 | polymeric carrier (wax) and isolated in | | (HCA) |
| | small spherical particles. ZnO | | |
| | concentration ~25 wt %. | | |
| Zinc oxide | Nano ZnO particles dispersed in non- | 1314-13-2 | Holland Colors |
| R8368 | polymeric carrier (wax) and isolated in | | (HCA) |
| | small spherical particles. ZnO | | |
| | concentration ~25 wt %. | | |
| Zinc acetate | Solid zinc acetate | 557-34-6 | Sigma Aldrich |
| dihydrate | | | |
| Zinc | Solid zinc stearate | 557-05-1 | Acros Organics |
| stearate | | | |
| Zinc carbonate | Solid zinc carbonate basic | 2-5-5263 | Acros Organics |
| basic | | | |
| Zinc nitrate | Solid zinc nitrate hexahydrate | 10196-18-6 | Sigma Aldrich |
| hexahydrate | | | |
| HS | Heat Stabilizer, tris (2,4-di-tert- | 31570-04-4 | BASF |
| | butylphenyl)phosphite; available under | | |
| | the trade name Irgafos ® 168; | | |

In each of the examples, sample batches (5 kg) were prepared by pre-blending all constituents in a dry-blend and tumble mixing for 20 minutes. The pre-blend was fed directly to a co-rotation twin screw extruder (25 mm) at a nominal melt temperature of 260° C., (700 mm) of mercury vacuum, 300 rpm, and rate of 10 kg/hr. The extrudate was pelletized and dried at about 100° C. for about 4 hours. To make test specimens, the dried pellets were injection molded to form appropriate test samples. Barrel-temperatures were 40/200/250/270/300/300/300° C., and typical molding conditions were: Mold T(° C.): 100, injection speed (mm/sec): 65, after pressure (bar): 50, temperature profile: 40/305/315/325/320° C.

The reference and inventive formulations described herein were evaluated on microbial growth, as well as on physical properties and molecular weight as described herein.

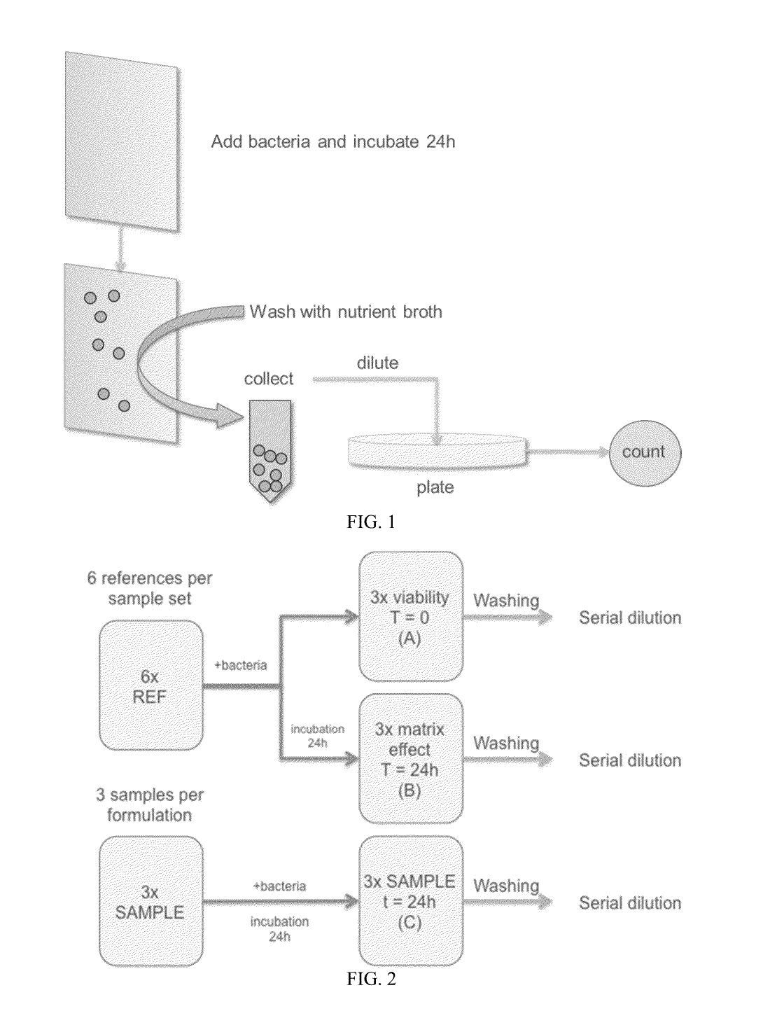

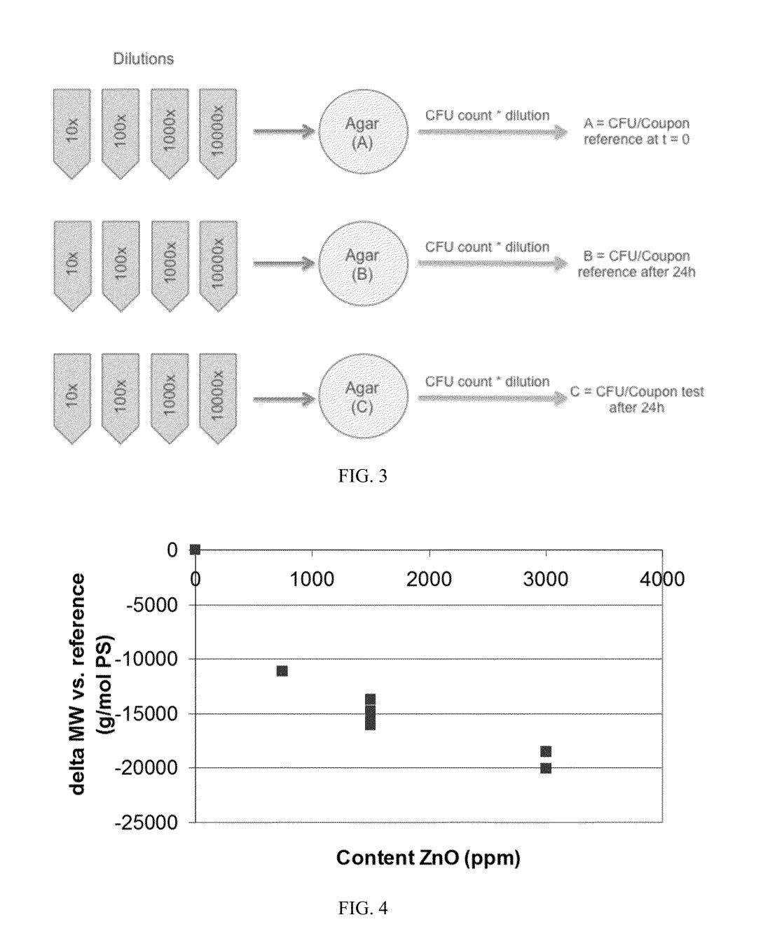

Antimicrobial testing was performed on the inventive formulations described herein according to the JIS Z 2801 norm (Antimicrobial products-Test for antimicrobial activity and efficacy) or its equivalent ISO 22196-2007 (Plastics—Measurement of antibacterial activity on plastics surfaces). These norms have been designed for standardizing the method for evaluating antimicrobial efficacy in antimicrobial products. FIG. 1 shows a visual schematic of the plating and counting methods used during testing the samples described herein for determining bacterial growth. FIGS. 2 and 3 shows a visual schematic of the incubation and serial dilution methods used during testing the samples described herein. Table 2 shows the log reduction and the corresponding reduction values in bacterial growth.

TABLE 2

| ¹⁰log reduction | reduction | % reduction |
|---|---|---|
| 1 | 10 x | 90 |
| 2 | 100 x | 99 |
| 3 | 1000 x | 99.9 |
| 4 | 10,000 x | 99.99 |
| 5 | 100,000 x | 99.999 |

Molecular weight (Mw) and Molecular number (Mn) were measured by GPC analysis of 1 mg/ml polymer solution in methylene chloride versus polystyrene standards and corrected for polycarbonate numbers.

Color (L, a, b and YI) was measurement was performed using a ColorEye™ 7000A spectrophotometer manufactured by GretagMacbeth, at an illuminant observer of C/2°. The CIE (L, a, b) values were determined on 2.5 mm color chips under transmission mode according to ASTM 6290. The color capability was determined from the absorbance spectral data according to the CIELAB color measurement method detailed by CIE (Commission Internationale de l'Eclairage). The values of L, a, and b are reported in Table 6 for the samples tested.

Transparency and Haze were measured using a Byk-Gardner Hazeguard according to ASTM D1003.

Heat deflection temperature (HDT) was determined according to ISO75:2004 using 0.45 megaPascal (Mpa) stress on the flat surface (method A). Measurements were performed on molded ISO bars (80×10×4 mm) which were preconditioned at 23° C. and 50% relative humidity for 48 hours. The heating medium of the HDT equipment was mineral oil. Measurements were performed in duplicate and are reported as an average value.

Notched Izod impact (NII) was determined according to ISO 180:2000, method A test protocol. The test was repeated five times on 80×10×3 mm molded impact bars which had been notched. The test specimens were conditioned at 23° C. and 50% relative humidity for 48 hours. The impact velocity was 3.5 m/s with a pendulum energy of 5.5 J. The clamping height was 40 mm. The test was conducted at 23° C. Results are reported as the average of the five measurements as KJ/m².

Tensile modulus, stress at yield, stress at break and strain at break were determined according to ISO527. The tensile speed was 1 millimeter/minute for testing modulus and 50 millimeters/minute for the other properties. Samples were conditioned for 2 days at 23° C. and 50% relative humidity prior to testing.

To determine the effect of different zinc additives on molecular weight, the formulations described herein were prepared with varying loadings. Typically an increased loading of the additive results in a reduction of molecular weight of the product, independent of the type of additive used. FIG. 4 shows the detrimental effect on molecular weight of zinc oxide, displayed as molecular weight plotted against the additive loading level (ppm).

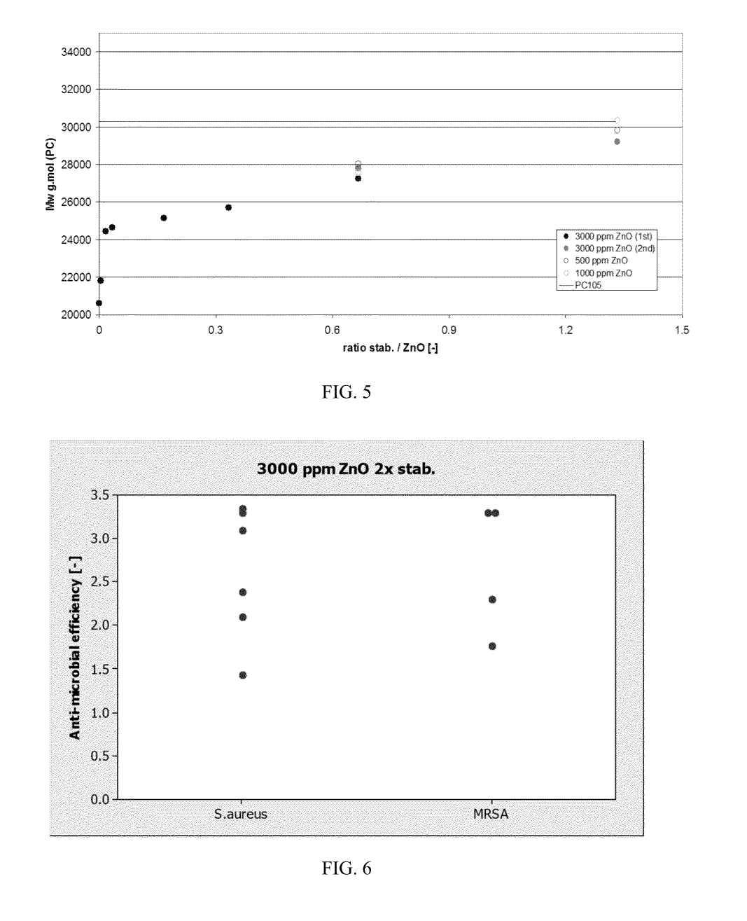

To counter this effect, acid stabilizers were evaluated in the formulations. As shown in FIG. 5, the detrimental effect on molecular weight has been countered by adding an acid stabilizer (phosphorous acid), in addition to a heat stabilizer (HS) to the formulation. For ZnO, the reduction of the molecular weight can be virtually eliminated at high stabilizer levels.

Furthermore, the effects of the loading of the zinc additive, acid stabilizer and their respective ratios on optical properties were evaluated. As seen in Table 3, a decrease in transmission was observed with increased loadings to a level of approximately 83% for 3000 ppm wt. ZnO. At higher ZnO levels the transmission deteriorates to as low as 30% at 1.2% wt. Zinc stearate performs remarkably better with ˜85% T at 0.8% wt. loading. As one of skill in the art can appreciate, higher loadings typically also negatively affect haze. However, transmission values improve slightly with the addition of the phosphorous acid stabilizer. For ZnO at a level of 3000 ppm, the transmission improved from 83% to 87% with a stabilizer/ZnO ratio of 1.3. This effect was not been observed for haze which remains approximately the same.

TABLE 3

| | Content | | Trans- | S. aureaus | MRSA |
|---|---|---|---|---|---|
| Additive | (ppm) | Haze (%) | mission (%) | (log R) | (log R) |
| PC reference | — | 0.58 | 90.9 | — | — |
| Nano ZnO MB | 3000 | 16.1 | 86.3 | 2.9 | 2.9 |
| Zinc stearate | 1000 | 0.84 | 90.5 | 3.0 | 3.1 |
| Zinc acetate | 3000 | 8.60 | 86.6 | 1.4 | 3.3 |

Furthermore, the antimicrobial properties of the zinc additive containing compositions were evaluated. The reported anti-microbial efficacy results shows varying results and are listed in Tables 3 and 4. The internationally accepted norm for anti-microbial efficacy testing, JIS Z 2801 dictates that the measured logarithmic reduction shall not be less than 2.0 in order for the material to be deemed anti-microbial.

TABLE 4

| Organism | Initial | | | |
|---|---|---|---|---|
| (2 min Sonication) | Suspension | A(t = 0) | B | C |
| S. aureus | 169 | 22/19 | 171/158 | 5/5 |
| | 173 | 14/16 | 116/110 | // |
| | 171 | 24/23 | 76/69 | // |
| CFU/coupon | 6.8 × 10⁴ | 2.0 × 10⁵ | 1.2 × 10⁶ | 5.0 × 10⁴ |
| MRSA | 243 | 12/12 | 173/192 | 13/12 |
| | 191 | 14/14 | 208/201 | 18/15 |
| | 217 | 13/12 | 240/256 | // |
| CFU/coupon | 8.7 × 10⁴ | 1.3 × 10⁵ | 2.1 × 10⁶ | 1.5 × 10⁵ |

As can be seen from Table 4, the C-value, which represents the colony forming unit (CFU) count on the test surface after 24 hours incubation, is equal to MRSA, and less than S. Aureus (A-value), the CFU count on the reference sample at t=0. This data indicates that bacterial growth is inhibited. In contrast the B-value increased, which is the number of CFUs on the reference sample after 24 hours incubation.

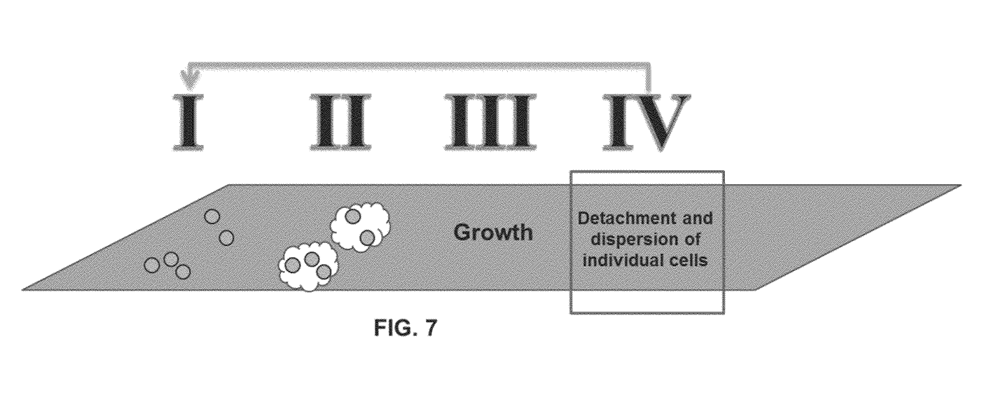

As shown in FIG. 6, the antimicrobial reports produced large spreads in logarithmic reduction for the negative control and anti-microbial efficacy of the inventive formulations. Furthermore, duplicate samples tested at different times gave varying results, including some samples that passed the anti-microbial criteria according to JIS Z 2801 standards and other samples that failed.

Without wishing to be bound by a particular theory, it is believed that formation of a biofilm on the surface of the reference samples prevented efficient removal of bacteria from those samples during analysis, causing a false basis for the determination of the logarithmic reduction of treated samples. As depicted in FIG. 7, biofilm formation is a common behavior exhibited by most bacteria species. In one aspect, it is believed that individual free-floating cells first populate the surface. Next, extracellular bio-polymeric substance is produced and released by the cell, and attachment becomes irreversible. The biofilm architecture then develops and matures. Finally, detachment and dispersion of individual cells from the biofilm occurs and the process (steps I-IV) repeats.

While an added sonication step in the present example aided removal of bacteria from the sample surfaces for adequate analysis, more efficient removal of bacteria from the test surface may ultimately be required. Accordingly, analysis conforming to JIS Z 2801 or its equivalent ISO22196 proved to be challenging and, therefore, the evaluated formulations did not consistently meet the anti-microbial designation requirements according to the testing standards.

While not all samples exhibited consistent >2.0 log reduction values, a consistent bacteriostatic effect was observed in test samples, including Formulation 3 (PC105+0.05% RMC205, 4000 ppm RMC202 and 3000 ppm ZnO). Table 5 below shows the additive loading levels for the reference PC105 samples (Formulation 1) and the inventive PC105 samples (Formulation 3). Table 6 shows a comparison of performance properties for reference Formulation 1 and representative Formulation 3.

TABLE 5

| Component | Formulation 1 | Formulation 3 |
|---|---|---|
| XP R8166 | 0 | 3000 ppm |
| RMC 202 | 0 | 4000 ppm |

TABLE 6

| | | Formu- | Formu- |
|---|---|---|---|
| Test | Unit | lation 1 | lation 3 |
| PS Mw | g/mol | 61046 | 58892 |
| PC Mw | g/mol | 30523 | 29446 |
| PC Mn | g/mol | 11829 | 11546 |
| PD | — | 2.58 | 2.55 |
| PC Mw | g/mol | 30205 | 28404 |
| PC Mn | g/mol | 11761 | 11157 |
| PD | — | 2.6 | 2.5 |
| Transmission | % | 91.1 | 86.6 |
| Haze | % | 0.79 | 17.7 |
| L | — | 95.906 | 94.538 |
| a | — | −0.043 | −0.009 |
| b | — | 0.552 | 1.150 |
| YI (D1925) | — | 1.25 | 2.43 |
| YI (E313) | — | 0.76 | 1.72 |
| Heat Deflection temp (HDT) (avg.) | ° C. | 143.80 | 136.30 |
| HDT St.dev. | ° C. | 0.30 | 0.50 |
| Chord Modulus-Avg | MPa | 2324.4 | 2418.8 |
| Stress@Yield-Avg | MPa | 63.81 | 67.44 |
| Stress@Break-Avg | MPa | 67.1 | 61.34 |
| Strain@Yield-Avg | % | 6.53 | 6.19 |
| Strain@Break-Avg | % | — | — |
| Nominal Strain@Break-Avg | % | 101.62 | 82.84 |
| Flexural Modulus | MPa | 2366 | 2358 |
| Flexural Strength | MPa | 2330 | 2329 |
| Stress at break | MPa | 92.5 | 95.8 |
| Strain at strength | % | 6.9 | 6.9 |
| Strain at break | % | 0.0 | 0.0 |
| Stress at 3.5% strn | MPa | 70.6 | 72.8 |
| Notched Izod impact (NII) | KJ/m² | 65.7 | 13.84 |
| NII St.dev. | KJ/m² | 6.49 | 2.28 |

As the data suggests, zinc oxide and zinc salts incorporated in polycarbonate blends as described herein inhibit bacterial growth, and can achieve R-values of >2.0. Moreover, the addition of phosphorous acid as a stabilizer counters the detrimental effect of zinc additive compounds on the molecular weight of polycarbonates.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A thermoplastic composition comprising
a. a thermoplastic polymer component comprising a polycarbonate, polyalkylene terephthalate, polypropylene (PP), polyphenylene oxide (PPO), polyetherimide (PEI), or a combination thereof;
b. a zinc additive component; and
c. an acid stabilizer component.

2. The thermoplastic composition of claim 1, comprising
a. from greater than 0 wt % to less than 100 wt % of a thermoplastic polymer component comprising a polycarbonate, polyalkylene terephthalate, polypropylene (PP), polyphenylene oxide (PPO), polyetherimide (PEI), or a combination thereof;
b. from greater than 0 wt % to about 10 wt % of a zinc additive component; and
c. from greater than 0 wt % to about 5 wt % of an acid stabilizer component.

3. The thermoplastic composition of claim 1, wherein the thermoplastic polymer component comprises at least one polycarbonate.

4. The thermoplastic composition of claim 1, wherein the thermoplastic polymer component is present in an amount in the range of from greater than 0 to 99 wt % relative to the total weight of the composition.

5. The thermoplastic composition of claim 1, wherein the thermoplastic polymer is present in an amount in the range of from greater than 0 to 95 wt % relative to the total weight of the composition.

6. The thermoplastic composition of claim 1, wherein the zinc additive component comprises zinc, zinc oxide, zinc acetate, zinc stearate, zinc carbonate, zinc nitrate, or a salt thereof, or a combination thereof.

7. The thermoplastic composition of claim 1, wherein the zinc additive component is present in the composition in an amount in the range of from greater than 0 to about 5 wt % relative to the total weight of the composition.

8. The thermoplastic composition of claim 1, wherein the acid stabilizer comprises phosphorous acid, phosphoric acid, mono zinc phosphate, mono sodium phosphate, or sodium acid pyrophosphate, or a combination thereof.

9. The thermoplastic composition of claim 8, wherein the acid stabilizer component is phosphorous acid.

10. The thermoplastic composition of claim 1, wherein the acid stabilizer component is present in the composition in an amount in the range of from greater than 0 to about 5 wt % relative to the total weight of the composition.

11. The thermoplastic composition of claim 1, further comprising an additive selected from thermal stabilizer, UV stabilizer, primary anti-oxidant, secondary anti-oxidant, mold release agent, lubricant, flame retardant agent, smoke suppressor agent, buffer, acid scavenger, hydrolytic stabilizer, quencher, pigment, and combinations of two or more of the foregoing.

12. The thermoplastic composition according to claim 1, wherein the thermoplastic composition exhibits antimicrobial properties against at least one microorganism.

13. The thermoplastic composition of claim 12, wherein the microorganism comprises staphylococcus aureus, methicillin-sensitive staphylococcus aureus (MSSA), or methicillin-resistant staphylococcus aureus (MRSA), or a combination thereof.

14. The thermoplastic composition according to claim 1, wherein a molded part formed from the thermoplastic composition exhibits antimicrobial properties against at least one microorganism.

15. The thermoplastic composition of claim 12, wherein the antimicrobial properties comprise microbiostatic activity, bacteriostatic activity, fungistatic activity, or a combination thereof.

16. The thermoplastic composition of claim 1, wherein a molded part formed from the thermoplastic composition exhibits a microorganism logarithmic reduction (log R) of at least 1.0 as determined according to JIS Z 2801.

17. The thermoplastic composition of claim 1, wherein a molded part formed from the thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component.

18. The thermoplastic composition of claim 1, wherein after a 24 hour incubation, a molded part formed from the thermoplastic composition exhibits a lower microorganism colony forming unit (CFU) value as determined according to JIS Z 2801, compared to a molded part formed from an identical reference composition comprising the same thermoplastic component, and the same weight percentage of the same acid stabilizer component, but in the absence of the zinc additive component.

19. A thermoplastic composition, comprising
a. from greater than 0 wt % to about 99 wt % of a thermoplastic polymer component comprising at least one polycarbonate;
b. from greater than 0 wt % to about 10 wt % of a zinc additive component comprising zinc, zinc oxide, zinc acetate, zinc stearate, zinc carbonate, zinc nitrate, or a salt thereof, or a combination thereof; and
c. from greater than 0 wt % to about 10 wt % of an acid stabilizer component comprising phosphorous acid, phosphoric acid, mono zinc phosphate, mono sodium phosphate, or sodium acid pyrophosphate, or a combination thereof;
wherein a molded part formed from the thermoplastic composition exhibits greater antimicrobial activity compared to a molded part formed from an identical reference composition comprising the same thermoplastic component, and the same weight percentage of the same acid stabilizer component, but in the absence of the zinc additive component.

20. The thermoplastic composition of claim 19, wherein a molded part formed from the thermoplastic composition exhibits greater bacteriostatic activity compared to a molded part formed from an identical reference composition comprising the same thermoplastic component, and the same weight percentage of the same acid stabilizer component, but in the absence of the zinc additive component.

21. The thermoplastic composition of claim 19, wherein a molded part formed from the thermoplastic composition exhibits a microorganism logarithmic reduction (log R) of at least 1.0 as determined according to JIS Z 2801.

22. The thermoplastic composition of claim 19, wherein a molded part formed from the thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component.

23. The thermoplastic composition of claim 19, wherein after a 24 hour incubation, a molded part formed from the thermoplastic composition exhibits a lower microorganism colony forming unit (CFU) value as determined according to JIS Z 2801, compared to a molded part formed from an identical reference composition comprising the same thermoplastic component, and the same weight percentage of the same acid stabilizer component, but in the absence of the zinc additive component.

24. An article of manufacture comprising the thermoplastic composition according to claim 1.

25. The article of claim 24, wherein the article is a medical device, surgical device, imaging device, monitoring device, blood care device, drug delivery device, interior trim, window, floor, cover, wall panel, door, enclosure, housing, panel, lighting switch, bedding part, furniture part, culinary device, food preparation device, food storage device, or food delivery device, or a combination thereof.

26. A method for forming an antimicrobial thermoplastic blend comprising:
a. combining:
i. a thermoplastic polymer component comprising a polycarbonate, polyalkylene terephthalate, polypropylene (PP), polyphenylene oxide (PPO), polyetherimide (PEI), or a combination thereof;
ii. a zinc additive component; and
iii. an acid stabilizer component.

27. The method of claim 26, wherein the zinc additive component comprises zinc, zinc oxide, zinc acetate, zinc stearate, zinc carbonate, zinc nitrate, or a salt thereof, or a combination thereof.

28. The method of claim 26, wherein the acid stabilizer component comprises phosphorous acid, phosphoric acid, mono zinc phosphate, mono sodium phosphate, or sodium acid pyrophosphate, or a combination thereof.

29. The method of claim 26, wherein a molded part formed from the thermoplastic composition exhibits greater antimicrobial activity compared to a molded part formed from an identical reference composition comprising the same thermoplastic component, and the same weight percentage of the same acid stabilizer component, but in the absence of the zinc additive component.

30. The method of claim 26, wherein a molded part formed from the thermoplastic composition exhibits a microorganism logarithmic reduction (log R) of at least 1.0 as determined according to JIS Z 2801.

31. The method of claim 26, wherein a molded part formed from the thermoplastic composition exhibits a greater microorganism logarithmic reduction (log R) as determined according to JIS Z 2801, compared to a molded part formed from an identical reference composition comprising the same thermoplastic component, and the same weight percentage of the same acid stabilizer component, but in the absence of the zinc additive component.

32. The method of claim 26, wherein after a 24 hour incubation, a molded part formed from the thermoplastic composition exhibits a lower microorganism colony forming unit (CFU) value as determined according to JIS Z 2801, compared to a molded part formed from an identical reference composition comprising the same thermoplastic component, and the same weight percentage of the same acid stabilizer component, but in the absence of the zinc additive component.
